(19) United States
(12) Patent Application Publication
(10) Pub. No.: US 2011/0111221 A1
(43) Pub. Date: May 12, 2011

(54) POLYURETHANE-BASED PRESSURE-SENSITIVE ADHESIVE

(75) Inventors: Uwe Schümann, Pinneberg (DE); Kirstin Weiland, Hamburg (DE); Rose-Marie Gouttefarde, Bayreuth (DE)

(73) Assignee: tesa SE, Hamburg (DE)

(21) Appl. No.: 12/917,771

(22) Filed: Nov. 2, 2010

(30) Foreign Application Priority Data
Nov. 12, 2009 (DE) 10 2009 046 657.6

(51) Int. Cl. C09J 7/02; C09J 175/04

(52) U.S. Cl. 428/355 N; 528/67; 524/590; 521/160

(57) ABSTRACT

Polyurethane-based pressure-sensitive adhesive wherein the polyurethane comprises the chemical reaction product of at least the following starting materials:
a) polyisocyanates comprising at least one aliphatic or alicyclic diisocyanate and at least one aliphatic or alicyclic polyisocyanate having an isocyanate functionality of three or more than three, the amount-of-substance fraction of the aliphatic or alicyclic polyisocyanates having an isocyanate functionality of three or more than three as a proportion of the polyisocyanates being at least 18 per cent, and
b) at least one pressure-sensitively adhesive, hydroxyl-functionalized polyurethane prepolymer.

The present invention relates to a pressure-sensitive adhesive (PSA) based on polyurethane, and also to a pressure-sensitively adhesive layer and an adhesive tape based on said PSA, to the use of said PSA as a pressure-sensitive adhesive layer, carrier layer or functional layer in an adhesive tape, and to processes for preparing it.

### BACKGROUND OF THE INVENTION

Pressure-sensitive adhesives have particular, characteristic viscoelastic properties. One characteristic thereof is that, when they are mechanically deformed, there may be both viscous flow processes and also development of elastic resilience forces. Both processes, in terms of their respective proportion, are in a particular ratio to one another, dependent not only on the precise composition, the structure and the degree of crosslinking of the PSA in question, but also on the rate and duration of the deformation, and on the temperature.

The proportional viscous flow is necessary in order to obtain adhesion. Only the viscous components, brought about by macromolecules with relatively great mobility, permit effective wetting and good flow onto the substrate to be bonded. A high viscous flow component results in high pressure-sensitive adhesiveness (also referred to as tack or surface stickiness) and hence often also in a high bond strength. Owing to a lack of flowable components, highly crosslinked systems or polymers that are crystalline or have undergone glasslike solidification generally are not pressure-sensitively adhesive or are only slightly pressure-sensitively adhesive.

The proportional elastic resilience forces are necessary in order to achieve cohesion. They are brought about, for example, by very long-chain, highly convoluted macromolecules, and also by physically or chemically crosslinked macromolecules, and allow the transfer of the forces which act on an adhesive bond. They enable an adhesive bond to withstand sufficiently, over a relatively long period of time, a long-term load which acts on it, in the form, for example, of a sustained shearing load.

For more precise description and quantification of the degree of elastic and viscous components, and also of the ratio of the components to one another, it is possible to employ the parameters—determinable by means of Dynamic Mechanical Analysis (DMA)—of storage modulus (G′), loss modulus (G″), and also the ratio G″/G′, which is identified as loss factor tan δ (tan delta). G′ is a measure of the elastic component, G″ a measure of the viscous component, of a substance. Both parameters are dependent on the deformation frequency and on the temperature.

The parameters can be determined by means of a rheometer. The material under analysis, in a plate/plate arrangement, for example, is subjected to a sinusoidally oscillating shearing stress. In the case of shear stress-controlled instruments, the deformation is measured as a function of time, and the time lapse of this deformation relative to the introduction of the shear stress is measured. This time lapse is identified as phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ is: G″=(τ/γ)·sin(δ) (τ=shear stress, γ=deformation, δ=phase angle=phase shift between shear stress vector and deformation vector).

A substance is generally pressure-sensitively adhesive when at room temperature in the frequency range from 10⁰ to 10¹ rad/sec, ideally in the frequency range from 10⁻¹ to 10² rad/sec, G′ is located at least partly in the range from 10³ to 10⁷ Pa and when G″ likewise is located at least partly in this range. Within this range, which in a matrix plot of G′ and G″ (G′ plotted as a function of G″) may also be termed the viscoelastic window for pressure-sensitive adhesive applications, or as the pressure-sensitive adhesive window, in accordance with viscoelastic criteria, there are, in turn, different sectors and quadrants which more closely characterize the pressure-sensitive adhesive properties to be expected from the associated substances. Substances with high G″ and low G′ within this window, for example, are generally notable for a high bond strength and a low shear strength, while substances with a high G″ and high G′ are notable both for a high bond strength and for a high shear strength.

Generally speaking, the findings concerning the relationships between rheology and pressure-sensitive adhesiveness are state of the art and are described, for example, in “Satas, Handbook of Pressure Sensitive Adhesive Technology, Third Edition, (1999), pp. 153-203”.

One of many supplementary or else alternative possibilities for describing and quantifying pressure-sensitive adhesiveness is the direct measurement of the tack by means of a tack-measuring instrument, an example being the Texture Analyser TA 2 from SMS (Stable Micro Systems). According to this method, a die of selected geometric form, for example a cylindrical die made from a selected material, for example from steel, is pressed with a defined force and velocity onto the sample under analysis, and is withdrawn again at a defined velocity after a defined time. The test result is the maximum force required for withdrawal, expressed in the units N.

A substance can be considered pressure-sensitively adhesive if, on measurement with a steel cylinder having a cylinder radius of 1 mm, a pressing velocity of the cylinder onto the substance to be measured of 0.1 mm/s, a pressing force of 5 N, a pressing time of 0.01 s, and a withdrawal velocity of 0.6 mm/s, the maximum force required for the withdrawal of the die is at least 0.1 N.

Adhesive tapes are frequently constructed from a plurality of layers which lie one above another and are anchored to one another chemically or physically. The adhesive properties of an adhesive tape are influenced not only by the adhesive properties of the pressure-sensitive adhesive but also by the viscoelastic properties of the other layers, and additionally by the thicknesses of the individual layers. The influence exerted on the adhesive properties of an adhesive tape is propagated, so to speak, through all the layers of an adhesive tape. Thus, for example, the viscoelastic properties of a carrier layer may also have consequences for the adhesive properties of an adhesive tape. Even the viscoelastic properties of functional layers in an adhesive tape may exert an effect on the adhesive properties of an adhesive tape. By functional layers are meant, for example, primer layers or layers with particular optical, electrical or heat-conducting properties, to give but a few examples.

In respect of the production of self-adhesive articles in a continuous coating operation, there are diverse known technologies. Fundamentally a distinction may be made between solvent-based and solvent-free technologies.

In solvent-based systems, the pressure-sensitively adhesive polymer or mixture is present in solution prior to coating. Shortly before coating onto a carrier or auxiliary carrier, a chemical crosslinker may be admixed. The type and concentration of the crosslinker are generally selected such that the crosslinking process is slow enough not to cause gelling in the solution even prior to coating. After coating has taken place, and after the evaporation of the solvent, the pressure-sensitively adhesive polymer or mixture is present in the form of a film or filmlike layer on the carrier or auxiliary carrier, and can be wound up, independently of whether the crosslinking process has already concluded or not. The film or filmlike layer is in a highly viscous state which is more like that of a solid than that of a liquid. The crosslinking influences this solid character of the film or filmlike layer, generally speaking, not to any marked extent. The solid character of the film or filmlike layer is the basic prerequisite for windability to a roll.

Solvent-based technologies have the fundamental disadvantage that they are not suitable for producing thick layers, especially not when coating is to take place at an economically acceptable speed. Even at layer thicknesses above about 100 to 150 μm, there is increased, visible blistering as a result of the evaporated solvent, and hence there are distinct quality detractions, meaning that the layer can then no longer be considered for use in adhesive tape. In the context of production of thinner layers as well, the coating speed is limited considerably by the need to evaporate the solvent. Moreover, solvent-based coating operations give rise to considerable operational costs as a result of the need for solvent recovery or incineration.

Solvent-free systems can be subdivided into reactive systems, which are liquid, syruplike or pastelike even without solvent at room temperature, and into hotmelt systems, where the pressure-sensitively adhesive polymer or mixture has sufficiently high viscosity at room temperature that it has the character of a solid and, when heat is supplied, melts or undergoes transition to a state allowing processing of the kind typical for liquid, syruplike or pastelike substances.

Typical examples for reactive systems which are liquid, syruplike or pastelike at room temperature are the well-known two-component polyurethanes, epoxides or silicones. Reactive systems of this kind can be used to produce both thin and thick layers, this being a great advantage over solvent-based systems.

In relation, however, to continuous coating, which generally represents the central operating step in a typical adhesive tape manufacturing procedure, reactive systems which are liquid, syruplike or pastelike at room temperature have the disadvantage that in this state they cannot be wound up, or at least not with constant layer thickness, especially not when the layer thicknesses are high. With constant layer thickness it is possible to wind up only those polymer films which are solid or at least of such high viscosity that they have the character of a solid. The solidification of solvent-free reactive systems that are liquid at room temperature is tied to the progress of a chemical reaction which in general begins only after the components have been mixed. Reaction progress requires a certain time. Only when the film has solidified as a result of a sufficiently high degree of conversion in the chemical reaction in question is it possible for the film coated onto a carrier or auxiliary carrier to be wound up. Accordingly, the coating speed for such systems is limited.

The polyurethane-based PSAs described in EP 1 469 024 A2, in EP 1 469 055 B1, in EP 1 849 811 A1 or in WO 2008/009542 fall within this category of reactive systems. As a film and/or PSA layer, as part of an adhesive tape, therefore, they can be produced only with a coating speed which is limited and hence, as a general rule, not very economic.

The polyurethane-based self-adhesive tape carriers described in EP 0 801 121 B1 and EP 0 894 841 B1 also, like the PSAs set out above, have the disadvantage that they are produced during coating from liquid or pastelike components. Here as well, therefore, it is necessary to wait for the progress of reaction until these carriers can be wound up, and this limits the coating speed and hence the economics of production.

The same disadvantage applies in respect of the substances produced by the process described in EP 1 095 993 B1 for the continuous production of self-adhesive articles from two-component polyurethanes.

Adhesive tapes or adhesive-tape layers based on syruplike components are described for example in EP 0 259 094 B1 or in EP 0 305 161 B1, where polymer buildup or crosslinking is achieved through photopolymerization.

These reactive systems as well have the disadvantage that in their syruplike state they cannot be wound up, or at least not with constant layer thickness. Here again, windability is tied to reaction progress, which requires a certain time. Hence these systems as well are limited in terms of coating speed.

Liquid, syruplike or pastelike reactive systems whose polymer buildup and whose crosslinking are initiated externally, as for example by UV or EBC radiation, have the additional disadvantage, in general, that polymer buildup with consistently homogeneous properties occurs only when the radiation, uniformly, reaches all of the molecules involved in polymer buildup, through the entire thickness of the film. Particularly at high layer thicknesses or with systems that are filled with fillers, this is not the case, and so such films then have an inhomogeneously crosslinked polymer framework.

As compared with the liquid, syruplike or pastelike reactive systems, hotmelt systems have the advantage that they can be used to obtain high coating speeds, especially in the context of their processing in extrusion operations. In extrusion operations, polymers which at room temperature are solid and meltable or are of such high viscosity that they have the character of a solid are melted or converted by temperature increase into a low-viscosity state, and in that state they are shaped to a film, and coated, generally, onto a carrier or auxiliary carrier. After cooling to room temperature and hence solidification have taken place, winding may be carried out immediately. The windability is not tied to the progress of a chemical reaction. The operating of cooling a film generally takes up only comparatively little time. Polymers which at room temperature have the character of a solid and can be processed in extrusion operations are generally referred to as hotmelts. As with the liquid, syruplike or pastelike reactive systems, hotmelts as well can be used to produce layers without any fundamental limitation on thickness. In the adhesive-tape area, it is primarily styrene block copolymer PSAs, described for example in DE 100 03 318 A1 or DE 102 52 088 A1, that are coated in this way.

Thermoplastic polyurethanes as well can be processed by hotmelt operations. DE 20 59 570 A describes, for example, a continuous one-step production process for a non-porous thermoplastic polyurethane.

The preparation of thermoplastically processable polyurethanes from an OH-terminated linear prepolymer prepared initially as an intermediate is described in DE10 2005 039 933 A, for example. DE 22 48 382 C2 as well describes the preparation of thermoplastic polyurethanes from OH-terminated prepolymers in a multi-stage operation. These specifications provide no indications of viscoelastic properties suitable for adhesive applications. In US 2007/0049719 A1 as well, hydroxyl-terminated polyurethane prepolymers are described. There again, no indications are given of viscoelastic properties suitable for adhesive applications.

Hydroxyl-terminated polyurethane prepolymers are likewise described in US 2007/0129456 A1. These polymers serve for producing synthetic leather, and are liquid or semisolid at room temperature. They comprise crystalline polyether polyol and crystalline polyester polyol. No indications are given of viscoelastic properties suitable for adhesive applications. Nor are there any indications given of these prepolymers having a sufficiently solid character to be wound up in the form of an adhesive-tape roll.

Hotmelt coating operations based on thermoplastic or thermoplastically processable polymers do have the advantages of a high achievable coating speed and the capacity to produce thick layers, but lead to polymer films which are not crosslinked or at least not adequately crosslinked, with the consequence that these films are unsuitable for use as adhesive-tape layers, for which a high long-term robustness, particularly at elevated temperatures, is a must.

The extrusion of polyurethane elastomers using triols that might lead to a crosslinked character in the elastomers is known from DE 19 64 834 A and from DE 23 02 564 C3, for example. These specifications, however, describe the reaction of liquid starting materials, with the attendant disadvantage that, before such elastomers are wound up, it is necessary to await the solidification that is dependent on reaction progress. Indications of viscoelastic properties suitable for adhesive applications in respect of the products produced by the processes described in these specifications are not given. In the processes described in these specifications, moreover, only isocyanate-terminated, rather than hydroxyl-terminated, prepolymers are used. The molecular weight of the triols used in these specifications has an upper limit of 500.

EP 135 111 B1 describes the preparation of polyurethanes which are branched, but are thermoplastically processable and hence not crosslinked, in a multi-stage process. Proposed as a first intermediate A is an OH-terminated prepolymer constructed from substantially linear polyhydroxyl compounds of relatively high molecular weight. The lower limit on the molecular weight of the polyhydroxyl compounds is put at 550. Indications of viscoelastic properties suitable for adhesive applications, or of hotmelt properties on the part of the OH-terminated prepolymer, are not given.

JP 2006/182795 describes a hydroxyl-functionalized polyurethane prepolymer formed from a polyether polyol mixture, consisting of a polyether diol and a polyether triol, and polyisocyanate. The average functionality of the polyol mixture is 2.2 to 3.4. Further, the reaction of this prepolymer with a polyfunctional isocyanate to form a film of adhesive is described. The hydroxyl-functionalized polyurethane prepolymer in JP 2006/182795, however, is not a hotmelt. In JP 2006/182795, the molecular weight of the diols is given a lower limit of 700. No indications are given of viscoelastic properties suitable for adhesive applications.

Hotmelt coating operations leading to crosslinked polymer films are known from DE 10 2004 044 086 A1, for example. Described therein is a method for producing an adhesive tape based on an acrylate hotmelt PSA, to which, in its melted state in an extruder, a thermal crosslinker is added.

One difficulty in the method described therein is the need first to polymerize the acrylate hotmelt PSA in a solvent and then to remove this solvent again by means of a concentrating extruder. A further disadvantage is the relatively high molar mass of the polyacrylate (weight-average M_{w}: 300 000 to 1 500 000 g/mol). High molar masses dictate high processing temperatures and hence operating costs, and in extrusion operations, moreover, may result in unequal polymer properties in longitudinal and transverse directions.

For hotmelt systems, especially for thick layers, a problem which regularly arises, owing to the high processing temperatures and the associated restriction for thermal crosslinking processes, is that—when the layers are crosslinked with actinic radiation—the thickness-restricted depth of penetration and thickness-dependent penetration intensity of the radiation means that homogeneous crosslinking throughout the layer is not possible.

A further common weakness of known hotmelt systems is that they cannot be crosslinked in such a way that they not only withstand long-term shearing load, particularly at elevated application temperatures, as for example in the range from about 50° C. to 70° C., but also develop a high bond strength on different substrates.

It is an object of the invention to provide a pressure-sensitive adhesive which is crosslinked homogeneously in such a way that it develops high bond strengths. The pressure-sensitive adhesive, advantageously, shall withstand a shearing load for a long time in the temperature range up to 70° C., and/or, in particular, shall avoid or at least reduce the disadvantages of the prior art.

With particular advantage the pressure-sensitive adhesive shall comply with one, and advantageously two or more, preferably all, of the following criteria:

The PSA shall optionally be producible both on a solvent basis and solventlessly in a hotmelt coating operation. It shall, optionally, be producible both in a continuous coating operation, as in an extrusion process, for example, and in a discontinuous process.

It shall preferably be able to be wound up with constant layer thickness in any of the specified alternative coating operations without the need first to await the progress of a chemical reaction in the course of coating.

It shall be amenable to use both as a PSA layer and as a carrier or functional layer, as part of an adhesive tape.

When used as component or as sole constituent of a PSA layer, it shall develop high bond strength on different substrates and shall also withstand a long-term shearing load, particularly in the raised temperature range from about 50° C. to 70° C. When used as a component or as a sole constituent of a carrier layer or functional layer in an adhesive tape, it shall likewise withstand long-term shearing loads and, by virtue of its viscoelastic properties, shall contribute to increasing the bond strength of the adhesive tape.

Both the storage modulus G′ and the loss modulus G″ of the PSA shall be located at least partly in the range from 10³ Pa to 10⁷ Pa, as determined at room temperature in the deformation frequency range from 10⁰ to 10¹ rad/sec, preferably in the deformation frequency range from 10⁻¹ to 10² rad/sec, by Dynamic Mechanical Analysis (DMA) with a shear rate-controlled rheometer in a plate/plate arrangement.

Alternatively or additionally, the PSA shall have a tack of at least 0.1 N, as determined at room temperature using the Texture Analyser TA 2 from SMS (Stable Micro Systems) on measurement with a steel cylinder having a cylinder radius of 1 mm, a pressing velocity of the cylinder on the substance to be measured of 0.1 mm/s, a pressing force of 5 N, a pressing time of 0.01 s and a withdrawal velocity of 0.6 mm/s.

The PSA, shaped as a layer, shall advantageously have equal properties in longitudinal and transverse directions.

### SUMMARY OF THE INVENTION

The invention accordingly provides a polyurethane-based pressure-sensitive adhesive characterized in that the polyurethane comprises the chemical reaction product of at least the following starting materials:

a) polyisocyanates comprising at least one aliphatic or alicyclic diisocyanate and at least one aliphatic or alicyclic polyisocyanate having an isocyanate functionality of three or more than three, the amount-of-substance fraction of the aliphatic or alicyclic polyisocyanates having an isocyanate functionality of three or more than three as a proportion of the polyisocyanates being at least 18 per cent, and
b) at least one pressure-sensitively adhesive, hydroxyl-functionalized polyurethane prepolymer.

### DETAILED DESCRIPTION

Polyisocyanates for the purpose of this specification are organic compounds which in their molecules contain two or more isocyanate groups (—NCO groups). Diisocyanates contain two isocyanate groups per molecule, polyisocyanates having an isocyanate functionality of three are triisocyanates and, accordingly, contain three isocyanate groups per molecule. Polyisocyanates having an isocyanate functionality of more than three contain, correspondingly, more than three isocyanate groups per molecule. Diisocyanates, triisocyanates and polyisocyanates having an isocyanate functionality of more than three each form a subgroup of the polyisocyanates. The amount-of-substance fraction of the aliphatic or alicyclic polyisocyanates having an isocyanate functionality of three or more than three as a proportion of the polyisocyanates is meant the relative number of aliphatic or alicyclic polyisocyanate particles having an isocyanate functionality of three or more than three as a proportion of the total number of polyisocyanate particles.

Aliphatic diisocyanates for the purposes of this specification are all diisocyanates in which the isocyanate groups are not attached directly to an aromatic ring or to an aromatic ring system. The NCO groups are therefore not in conjugation to an aromatic ring or ring system. Aliphatic polyisocyanates having an isocyanate functionality of three or more than three, accordingly, are all polyisocyanates having an isocyanate functionality of three or more than three in which the isocyanate groups are not attached directly to an aromatic ring or to an aromatic ring system.

Alicyclic polyisocyanates for the purposes of this specification are all aliphatic polyisocyanates in which at least one NCO group is attached to a cyclic aliphatic chain. Alicyclic polyisocyanates form a subgroup of the aliphatic polyisocyanates.

Examples of suitable diisocyanates according to the invention are butane 1,4-diisocyanate, tetramethoxybutane 1,4-diisocyanate, hexane 1,6-diisocyanate (hexamethylene diisocyanate, HDI), bis(4-isocyanatocyclohexyl)methane (dicyclohexylmethane 4,4′-diisocyanate), ethylene diisocyanate, 2,2,4-trimethylhexa-methylene diisocyanate, ethylethylene diisocyanate, 1,4-diisocyanatocyclohexane, 1,3-diisocyanatocyclohexane, 1,2-diisocyanatocyclohexane, 1,3-diisocyanatocyclopentane, 1,2-diisocyanatocyclopentane, 1,2-diisocyanatocyclobutane, 5-isocyanato-1-(isocyanatomethyl)-1,3,3-trimethylcyclohexane (isophorone diisocyanate, IPDI), 1-methyl-2,4-diisocyanatocyclohexane, 1,6-diisocyanato-2,2,4-trimethylhexane, 1,6-diisocyanato-2,4,4-trimethylhexane, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-1-(4-isocyanatobut-1-yl)-1,3,3-trimethylcyclohexane, 1-isocyanato-2-(3-isocyanatoprop-1-yl)cyclohexane, 1-isocyanato-2-(2-isocyanatoeth-1-yl)cyclohexane, 2-heptyl-3,4-bis(9-isocyanatononyl)-1-pentylcyclohexane, norbornane diisocyanatomethyl, m-tetramethylxylene diisocyanate (TMXDI), chlorinated, brominated, sulphur- or phosphorus-containing aliphatic or alicyclic diisocyanates, derivatives of the cited diisocyanates, especially dimerized or polymerized types containing, for example, uretdione groups or allophanate groups, and mixtures of the stated isocyanates. Particularly suitable is the dimeric HDI uretdione present with an amount-of-substance fraction of 64 per cent in Desmodur N3400®, which in turn is a mixture of a number of different polyisocyanates, the amount-of-substance fraction of all the diisocyanates present therein amounting together to a total of 83 per cent.

Suitable polyisocyanates according to the invention and having an isocyanate functionality of three or more than three are, for example, trimerized or more highly oligomerized aliphatic or alicyclic diisocyanates, such as the trimeric, pentameric or more oligomerized HDI isocyanurates that are present in Desmodur N3300® or Desmodur N3600®, HDI biurets, which are present in Desmodur N100® or Desmodur N 3200®, the mixture of an HDI iminooxadiazinedione and an HDI isocyanurate in Desmodur XP 2410®, or the IPDI isocyanurate present in Desmodur Z 4470®, each from the company Bayer, and also derivatives of the cited polyisocyanates having an isocyanate functionality of three or more than three, or mixtures thereof.

A hydroxyl-functionalized polyurethane prepolymer for the purposes of this specification is a substance that contains urethane groups and carriers terminal hydroxyl groups. It is the chemical product of reaction of one or more polyols with at least one polyisocyanate, the number of hydroxyl groups participating in the reaction to form the polyurethane prepolymer being greater than the number of isocyanate groups. The chemical reaction to give the hydroxyl-functionalized polyurethane prepolymer may involve the participation not only of the polyols but also of other isocyanate-reactive substances, suc as amino-functionalized polyethers, for example.

It is also possible in accordance with the invention for there to be more than one hydroxyl-functionalized polyurethane prepolymer in the starting materials (e.g. two, three or more polyurethane prepolymers, which in particular can be mixed with one another as a blend), meaning then that there is more than one polyurethane prepolymer able to react with the isocyanates.

A hydroxyl-functionalized polyurethane prepolymer for the purposes of this specification is not crosslinked and is therefore meltable and/or soluble in a suitable solvent. These properties are considered in this specification to form part of the fundamental definition of a prepolymer. In one advantageous embodiment, the hydroxyl-functionalized polyurethane prepolymer contains branched molecular chains and therefore has a hydroxyl functionality of more than two.

Polyols contemplated for preparing a hydroxyl-functionalized polyurethane prepolymer include all known polyols such as, for example, polyether polyols, especially polyethylene glycols or polypropylene glycols, polyester polyols, polycarbonate polyols, polytetramethylene glycol ethers (polytetrahydrofurans), hydrogenated and non-hydrogenated hydroxyl-functionalized polybutadiene derivatives, hydrogenated and non-hydrogenated hydroxyl-functionalized polyisoprenes, hydroxyl-functionalized polyisobutylenes, hydroxyl-functionalized polyolefins or hydrogenated and non-hydrogenated hydroxyl-functionalized hydrocarbons. Preferred polyols are polypropylene glycols. As polypropylene glycols it is possible to use all commercial polyethers based on propylene oxide and on a difunctional starting compound, in the case of the diols, and on a trifunctional starting compound, in the case of the triols. These include not only the polypropylene glycols prepared conventionally, i.e., in general, with a basic catalyst, such as potassium hydroxide, for example, but also the particularly pure polypropylene glycols which are prepared with DMC (double metal cyanide) catalysis and whose preparation is described in, for example, U.S. Pat. No. 5,712,216, U.S. Pat. No. 5,693,584, WO 99/56874, WO 99/51661, WO 99/59719, WO 99/64152, U.S. Pat. No. 5,952,261, WO 99/64493 and WO 99/51657. A characteristic of the DMC-catalyzed polypropylene glycols is that the “nominal” or theoretical functionality of exactly 2 in the case of the diols or exactly 3 in the case of the triols is also actually approximated. With the conventionally prepared polypropylene glycols, the “true” functionality is always somewhat lower than its theoretical counterpart, and this is the case particularly with polypropylene glycols having a relatively high molar mass. The reason is a secondary rearrangement reaction of the propylene oxide to give allyl alcohol. It is also possible, moreover, to use all polypropylene glycol diols and triols in which ethylene oxide is copolymerized as well, this being the case in many commercial polypropylene glycols, in order to achieve an increased reactivity with respect to isocyanates.

Other isocyanate-reactive substances as well, such as polyetheramines, for example, may be involved in the synthesis of the hydroxyl-functionalized polyurethane hotmelt prepolymer.

Generally, for the purposes of this specification, isocyanate-reactive substances are all substances containing active hydrogen. Active hydrogen is defined as hydrogen which is bonded to nitrogen, oxygen or sulphur and which reacts with methylmagsium iodide in butyl ethers or other ethers in a reaction in which methane is evolved.

Polyols contemplated for preparing a hydroxyl-functionalized polyurethane prepolymer also include chain extenders. Chain extenders for the purposes of this specification are all isocyanate-reactive compounds having a functionality of less than or equal to two and a number-average molar mass of less or equal to 500 g/mol. In general these are difunctional compounds of low molar mass such as, for example, 1,2-ethanediol, 1,2-propanediol, 1,3-propanediol, 2-methyl-1,3-propanediol, 1,4-butanediol, 2,3-butanediol, propylene glycol, dipropylene glycol, 1,4-cyclohexanedimethanol, hydroquinone dihydroxyethyl ether, ethanolamine, N-phenyldiethanolamine, or m-phenylenediamine. The chain extender title also, however, embraces the above-described polyols, especially the polypropylene glycols, provided that their functionality is less than or equal to two and their number-average molar mass is less than or equal to 500 g/mol.

Crosslinkers as well are contemplated as polyols for preparing a hydroxyl-functionalized polyurethane prepolymer. Crosslinkers are isocyanate-reactive compounds of low molar mass that have a functionality of more than two. Examples of crosslinkers are glycerol, trimethylolpropane, diethanolamine, triethanolamine and/or 1,2,4-butanetriol.

Monofunctional, isocyanate-reactive substances, such as monools, for example, may likewise be used polyols. They serve as chain terminators and may therefore be used to control the chain lengths in the hydroxyl-functionalized polyurethane prepolymer.

Polyisocyanates contemplated for preparing a hydroxyl-functionalized polyurethane prepolymer include all known aliphatic, alicyclic and/or aromatic polyisocyanates. Aromatic polyisocyanates for the purposes of this specification are all isocyanates in which one or more isocyanate groups are attached directly to an aromatic or to an aromatic ring system. Examples of aromatic polyisocyanates are tolylene diisocyanate (TDI) or diphenylmethane 4,4′-diisocyanate (MDI), and also polyisocyanates derived from these, such as dimerized, trimerized or polymerized types, for instance.

A hydroxyl-functionalized polyurethane prepolymer is pressure-sensitively adhesive for the purposes of this specification when, after having been brought into contact with a non-pressure-sensitively adhesive substrate or with itself, and when gentle or moderately strong pressing onto this substrate or itself is effected, it requires a certain force to detach it from this substrate or from itself again, or it can no longer be detached without residue or destruction. Pressure-sensitive adhesiveness, as already stated, is associated with particular, characteristic viscoelastic properties of the pressure-sensitively adhesive substance.

For more precise description of pressure-sensitive adhesiveness it is possible to employ the parameters—determinable by means of Dynamic Mechanical Analysis (DMA)—of storage modulus (G′) and loss modulus (G″). G′ is a measure of the elastic component, G″ a measure of the viscous component of a substance. Both parameters are dependent on the deformation frequency and on the temperature.

The parameters can be determined using a rheometer. The hydroxyl-functionalized polyurethane prepolymer is subjected to a sinusoidally oscillating shearing stress in a plate/plate arrangement, for example. In the case of shear stress-controlled instruments, the deformation is measured as a function of time, and the time lapse of this deformation is measured relative to the introduction of the shearing stress. This time lapse is identified as phase angle δ.

The storage modulus G′ is defined as follows: G′=(τ/γ)·cos(τ)=shear stress, γ=deformation, δ=phase angle=phase shift between shear stress vector and deformation vector). The definition of the loss modulus G″ is: G″=(τ/γ)·sin(τ)=shear stress, γ=deformation, δ=phase angle=phase shift between shear stress vector and deformation vector). The definition of angular frequency is as follows: ω=2π·f (f=frequency). The unit is rad/sec.

A suitable thickness for the hydroxyl-functionalized polyurethane prepolymer to be measured is between 0.9 and 1.1 mm (1±0.1 mm). A suitable sample diameter is 25 mm. Pre-tensioning may take place with a load of 3 N. A sample-element stress of 2500 Pa is appropriate.

A hydroxyl-functionalized polyurethane prepolymer is pressure-sensitively adhesive, for the purposes of this specification, when at room temperature in the frequency range (angular frequency range) from 10⁰ to 10¹ rad/sec, ideally in the frequency range from 10⁻¹ to 10² rad/sec, G′ is located at least partly in the range from 10³ to 10⁷ Pa and when G″ likewise is located at least partly in this range.

One of many supplementary or else alternative possibilities for the description of pressure-sensitive adhesiveness is the direct measurement of the tack by means of a tack-measuring instrument, an example being the Texture Analyser TA 2 from SMS (Stable Micro Systems). According to this method, a die of selected geometric form, for example a cylindrical die made from a selected material, for example from steel, is pressed with a defined force and velocity onto the hydroxyl-functionalized polyurethane prepolymer to be measured, and is withdrawn again at a defined velocity after a defined time. The test result is the maximum force required for withdrawal, expressed in the units N.

A hydroxyl-functionalized polyurethane prepolymer is pressure-sensitively adhesive for the purposes of this specification, in particular, when, on measurement with a steel cylinder having a cylinder radius of 1 mm, with a pressing velocity of the cylinder onto the hydroxyl-functionalized polyurethane prepolymer to be measured of 0.1 mm/s, a pressing force of 5 N, a pressing time of 0.01 s, and a withdrawal velocity of 0.6 mm/s, the maximum force needed to withdraw the die is at least 0.1 N.

A characteristic of pressure-sensitively adhesive substances, as already described, is that when they are mechanically deformed there are not only viscous flow processes but also the buildup of elastic resilience forces. Buildup of elastic resilience forces, however, can occur only when a pressure-sensitively adhesive substance has a high enough viscosity that in terms of its character it resembles more closely a solid than a liquid. For the purposes of this specification, accordingly, in terms of its character, a pressure-sensitively adhesive substance is more solid than liquid.

One possibility for describing this aspect of pressure-sensitive adhesiveness lies in the measurement of the complex viscosity.

Like the parameters of storage modulus (G′) and loss modulus (G″), the complex viscosity can be determined by means Dynamic Mechanical Analysis (DMA).

The measurements can take place using a shear stress-controlled rheometer in an oscillation experiment with a sinusoidally oscillating shearing stress in a plate/plate arrangement. The complex viscosity η* is defined as follows: η*=G*/ω

(G*=complexer shear modulus, ω=angular frequency).

The further definitions are as follows: G*=\sqrt{(G′)²+(G″)²}

(G″=viscosity modulus (loss modulus), G′=elasticity modulus (storage modulus)).
G″=τ/γ·sin(δ) (τ=shear stress, γ=deformation, δ=phase angle=phase shift between shear stress vector and deformation vector).
G′=τ/γ·cos(δ) (τ=shear stress, γ=deformation, δ=phase angle=phase shift between shear stress vector and deformation vector).
ω=2π·f (f=frequency).

A preferred embodiment of a pressure-sensitively adhesive, hydroxyl-functionalized polyurethane prepolymer for the purposes of this specification has a complex viscosity η* at room temperature, measured at an oscillation frequency of 10 rad/s, of at least 8000 Pas, preferably at least 10 000 Pas.

Room temperature in this specification means the temperature range of 23° C.+/−2° C.

Moreover, one preferred embodiment of a pressure-sensitively adhesive, hydroxyl-functionalized polyurethane prepolymer for the purposes of this specification has a weight-average molar mass in the range from about 50 000 to 150 000 g/mol. This range corresponds with the preferred complex viscosity η* and permits trouble-free coating as a hotmelt, without producing notable differences (i.e. differences which are disruptive in the utilities) in the properties of the resultant films (layers) in longitudinal and transverse directions.

As far as the precise composition of a pressure-sensitively adhesive, hydroxyl-functionalized polyurethane prepolymer is concerned, there are diverse possibilities. A pressure-sensitively adhesive, hydroxyl-functionalized polyurethane prepolymer is, as described, the chemical product of reaction of one or more polyols with at least one polyisocyanate, the number of hydroxyl groups involved in the reaction to the polyurethane prepolymer being greater than the number of isocyanate groups. In one preferred embodiment, a pressure-sensitively adhesive, hydroxyl-functionalized polyurethane prepolymer is obtained by reaction of a polypropylene glycol having a functionality of more than two and a number-average molar mass of greater than or equal to 3000 g/mol, a polypropylene glycol having a functionality of less than or equal to two and a number-average molar mass of less than or equal to 1000 g/mol, and a chain extender having a functionality of two and a number-average molar mass of less than 500 g/mol, with an aliphatic or alicyclic diisocyanate.

In one possible embodiment, the pressure-sensitive adhesive of the invention and also the pressure-sensitively adhesive, hydroxyl-functionalized polyurethane prepolymer of the invention comprise other additives (formulating constituents), such as, for example, fillers, microbeads, resins, especially tackifying hydrocarbon resins, plasticizers, ageing inhibitors (antioxidants), light stabilizers, UV protectants, rheological additives, and other auxiliaries and adjuvants.

Fillers which can be used include reinforcing fillers, such as carbon black, for example, and non-reinforcing fillers, such as chalk or barium sulphate, for example. Other examples are talc, mica, fumed silica, silicates, zinc oxide, solid glass microbeads, hollow glass microbeads and/or plastics microbeads of all kinds. Mixtures of the substances stated may also be used.

The use of microbeads leads in general to a foamlike consistency on the part of the pressure-sensitive adhesive, this consistency being advantageous in many cases. A foamed condition on the part of the PSA may also be obtained by other measures, such as by the introduction of gas or by gas generated by means of a secondary chemical reaction during the reaction according to claim 1, for example.

The use of antioxidants is advantageous though not mandatory.

The suitable antioxidants include, for example, sterically hindered phenols, hydroquinone derivatives, amines, organic sulphur compounds or organic phosphorus compounds. Light stabilizers and UV absorbers may optionally also be employed.

Light stabilizers and UV absorbers used include, for example, the compounds disclosed in Gaechter and Müller, Taschenbuch der Kunststoff-Additive, Munich 1979, in Kirk-Othmer (3rd) 23, 615 to 627, in Encycl. Polym. Sci. Technol. 14, 125 to 148, and in Ullmann (4th) 8, 21; 15, 529, 676.

Examples of rheological additives which may optionally be added are fumed silicas, phyllosilicates (bentonites), high molecular mass polyamide powders or powdered castor oil derivatives.

The additional use of plasticizers is likewise possible, but ought preferably to be avoided on account of their strong migration tendencies.

In order to accelerate the reaction of the pressure-sensitively adhesive, hydroxyl-functionalized polyurethane prepolymer with the polyisocyanates, it is possible to use one or more catalysts known to the skilled person, such as tertiary amines, organobismuth compounds or organotin compounds, for example, to name but a few.

With great advantage it is possible to use catalysts comprising bismuth and carbon, preferably a bismuth carboxylate or a bismuth carboxylate derivative.

The concentration of the catalysts is harmonized with the polyisocyanates and polyols used and also with the desired residence time in the mixing assembly, the temperature in the mixing assembly and/or the desired pot life. Generally speaking, the concentration is between 0.01% by weight and 0.5% by weight of the polyurethane to be prepared.

The reaction of the pressure-sensitively adhesive, hydroxyl-functionalized polyurethane prepolymer with the polyisocyanates may take place continuously or batchweise.

The term “continuously” relates to the process regime and means that, during mixing, the substances to be mixed are supplied continually and in particular at a uniform rate to the mixing assembly, in other words are introduced into said assembly, and the mixture in which the gradual chemical reaction to give the polyurethane progresses leaves continually and in particular at a uniform rate at another location from the mixing assembly. In the mixing assembly, therefore, in the course of mixing, there is a continual, especially uniform, flow process and/or transport process. The residence time of the substances in the mixing assembly from introduction to departure in the form of a chemically reacting mixture (in particular, therefore, the reaction time of the pressure-sensitively adhesive, hydroxyl-functionalized polyurethane prepolymer with the polyisocyanates prior to shaping) preferably does not exceed 10 minutes and very preferably amounts to 2 seconds to 5 minutes.

A continuous process regime is especially appropriate when the reaction between the pressure-sensitively adhesive, hydroxyl-functionalized polyurethane prepolymer and the polyisocyanates is started in the melt (in particular, therefore, solventlessly).

A pressure-sensitively adhesive, hydroxyl-functionalized polyurethane prepolymer is considered in this specification to be melted when the viscosity is lowered to such an extent, by temperature increase of the pressure-sensitively adhesive, hydroxyl-functionalized polyurethane prepolymer, that it can be mixed homogeneously with the polyisocyanates in known mixing assemblies. The temperature increase in the pressure-sensitively adhesive, hydroxyl-functionalized polyurethane prepolymer may take place by heating from the outside or may be generated by shearing. Examples of known mixing assemblies include kneading devices, internal mixers, extruders, planetary roller extruders, planetary mixers, butterfly mixers or dissolvers.

The continuous mixing of the melted, pressure-sensitively adhesive, hydroxyl-functionalized polyurethane prepolymer according to the invention with the polyisocyanates according to the invention takes place preferably in a continuously operating mixing assembly, preferably in an extruder, more particularly a twin-screw or planetary roller extruder, or in a heatable two-component mixing and metering system. Connected cascades of continuous or batch mixing assemblies are likewise suitable. The design of the mixing assembly is preferably such that effective mixing is ensured in a short residence time in the mixing assembly. The addition of the melted pressure-sensitively adhesive hydroxyl-functionalized polyurethane prepolymer according to the invention and of the polyisocyanates according to the invention may take place, in an extruder, at the same location or else at different locations, preferably in unpressurized zones. It is beneficial for the polyisocyanates according to the invention to be added in finely divided form to the pressure-sensitively adhesive, hydroxyl-functionalized polyurethane prepolymer according to the invention, such as in the form of an aerosol or fine droplets, for example.

The pressure-sensitively adhesive, hydroxyl-functionalized polyurethane prepolymer according to the invention may also be heated in a two-component mixing and metering system and be conveyed in the melted state, as component A, with heating, while the polyisocyanates according to the invention are conveyed as component B. Continuous mixing then takes place in a dynamic mixing head or, preferably, in a static mixing tube, or in a combination of dynamic and static mixing methods.

Optionally, during the continuous mixing of the pressure-sensitively adhesive, hydroxyl-functionalized polyurethane prepolymer according to the invention, in the melt, with the polyisocyanates according to the invention, further formulating constituents may be admixed, such as, for example, fillers, microbeads, resins, especially tackifying hydrocarbon resins, plasticizers, ageing inhibitors (antioxidants), light stabilizers, UV absorbers, rheological additives, and also other auxiliaries and adjuvants.

During and after the continuous mixing of the pressure-sensitively adhesive, hydroxyl-functionalized polyurethane prepolymer according to the invention, in the melt, with the polyisocyanates, the chemical reaction to form the polyurethane progresses continuously. Without catalysis or with moderate catalysis with a suitable catalyst, the reaction rate is sufficiently slow to allow thermoplastic processing for some period of time. During this time, which is generally in the region of minutes, the warm or hot, chemically reacting mixture may be shaped continuously to form a film. After shaping has taken place, the film can be cooled to room temperature, which causes it to solidify immediately, independently of the progress of the chemical reaction. Even at room temperature, the reaction to form the polyurethane progresses further until completeness is reached. At room temperature, the chemical reaction to form the polyurethane is concluded completely after, in general, one to two weeks. Following complete reaction, the resulting polyurethane is generally crosslinked chemically to such an extent that it is no longer meltable.

The continuous shaping of the warm or hot, chemically reacting mixture takes place preferably by means of roll application or by means of an extrusion die, but may also take place with other application methods, such as, for example, a comma bar. The shaped film is applied continuously to an incoming web of carrier material, and is subsequently wound up. The incoming web of carrier material may be, for example, an antiadhesively treated film or an antiadhesively treated paper. Alternatively it may be a material already coated with a pressure-sensitive adhesive or with a functional layer, or may be a carrier, or may be any desired combination of the stated web materials.

Where the pressure-sensitively adhesive, hydroxyl-functionalized polyurethane prepolymer according to the invention already contains branches, the skilled person must accept that, following metered addition of the polyisocyanates to this prepolymer in the melt, in other words at temperatures well above room temperature, immediate gelling takes place, i.e., immediately, crosslinked structured are formed which make it impossible to carry out further mixing and subsequent coating and shaping to form the film. The fact that this does not occur was unforeseeable to the skilled person.

Since, as a result of hotmelt coating, the windability of the film is not tied to the progress of a chemical reaction or to the rate of evaporation of a solvent, but instead only to the speed with which the film cools, it is possible to attain very high coating speeds, and this constitutes an economic advantage. Moreover, there are no costs incurred for heating a heating tunnel section or for solvent incineration or solvent recovery. Since the pressure-sensitively adhesive, hydroxyl-functionalized polyurethane prepolymer of the invention can be prepared solventlessly, there are no costs incurred there either for solvent incineration or recovery.

As a result of the possibility of absence of solvent, it is possible in principle to produce polymer films of any desired thickness, without foaming or bubbling due to evaporating solvent.

With the process of the invention it is possible in particular to produce very homogeneous (homogeneously crosslinked) thick layers and homogeneously crosslinked three-dimensional shaped structures. Homogeneous layer thicknesses of more than 100 μm, even more than 200 μm, can be produced outstandingly.

The process set out above is suitable especially for producing viscoelastic adhesive tapes (single-layer constructions or else multi-layer constructions, with two or three layers, for instance) having layer thicknesses of between 100 μm and 10 000 μm, preferably between 200 μm and 5000 μm, more preferably between 300 μm and 2500 μm.

Since the continuous admixing of the polyisocyanates that bring about chemical crosslinking to the pressure-sensitively adhesive, hydroxyl-functionalized polyurethane prepolymer of the invention only takes place shortly before the shaping of the mixture to form the film, there is no need for blocking of reactive groups, and hence no need to use blocking agents. Accordingly, at no point in time is there release of blocking agents remaining in the film that might possibly disrupt the subsequent application.

The pressure-sensitively adhesive, hydroxyl-functionalized polyurethane prepolymer according to the invention may also be stored or prepared in a solvent or a solvent mixture. In a solvent or solvent mixture it may also be reacted with the polyisocyanates and coated from solution during the beginning of the reaction phase between the prepolymer and the polyisocyanates. Examples of suitable solvents are methyl ethyl ketone, acetone, butyl acetate, decalin or tetrahydrofuran. It has surprisingly been found that the pot life of the reactive mixture in suitable solvents, especially in acetone, uncatalyzed or with moderate catalysis, amounts to at least several hours, usually indeed several days. For the reaction of a pressure-sensitively adhesive, hydroxyl-functionalized polyurethane prepolymer with polyisocyantes, according to claim 1, in a solvent, therefore, a batchwise preparation process is available.

Since the crosslinking is not initiated from the outside by radiation, such as UV or EBC radiation, for example, a polymer structure with consistently homogeneous properties is achieved even when the film produced is very thick or when the film includes sizable amounts of fillers. Fillers can be incorporated in sizable amounts of, for example, 50% or more.

As a result of the fact that, as a general rule, the weight-average molar mass of the pressure-sensitively adhesive, hydroxyl-functionalized polyurethane prepolymer according to the invention is low by comparison with numerous other thermoplastically processable polymers, it can be melted and processed thermoplastically at comparatively low temperatures. During and after the shaping of the melt to form a film, there are, as a general rule, no technically relevant differences in the film in longitudinal and transverse directions.

The invention further provides a pressure-sensitively adhesive, shaped structure, preferably a pressure-sensitively adhesive layer, comprising at least one polyurethane-based pressure-sensitive adhesive as described in at least one of the claims, particularly in claim 1, and/or as described above in this specification. A pressure-sensitively adhesive, shaped structure of this kind may be obtained by shaping of the pressure-sensitively adhesive, hydroxyl-functionalized polyurethane prepolymer during the phase of its reaction with the polyisocyanates. The invention additionally provides an adhesive tape comprising at least one pressure-sensitively adhesive layer, comprising at least one pressure-sensitive adhesive as described in at least one of the claims, more particularly in claim 1, and/or as described above in this specification.

Surprisingly and also unforeseeably for the skilled person, a polyurethane-based pressure-sensitive adhesive as described in at least one of the claims, more particularly in claim 1, and/or as described above in this specification, comprising the chemical product of reaction of at least the following starting materials:

a) polyisocyanates comprising at least one aliphatic or alicyclic diisocyanate and at least one aliphatic or alicyclic polyisocyanate having an isocyanate functionality of three or more than three, the amount-of-substance fraction of the aliphatic or alicyclic polyisocyanates having an isocyanate functionality of three or more than three as a proportion of the polyisocyanates being at least 18 per cent, and
b) at least one pressure-sensitively adhesive, hydroxyl-functionalized polyurethane prepolymer
achieves viscoelastic properties of the type required in the adhesive-tape sector in order to obtain high bond strengths in conjunction with high shear strengths, especially in the elevated temperature range up to 70° C. Particularly advantageous high bond strengths in conjunction with high shear strengths at 70° C. are achieved, surprisingly, when the amount-of-substance fraction of the aliphatic or alicyclic polyisocyanates having an isocyanate functionality of three or more than three as a proportion of the polyisocyanates is between at least 20 per cent and at most 90 per cent, preferably between at least 25 per cent and at most 70 per cent. A certain degree of viscous flow is always necessary, as is known, for developing adhesion on substrates to be bonded. Likewise, a certain degree of elastic resilience forces (cohesion) is necessary in order to be able to withstand shearing stresses, especially under hot conditions. Advantageous pressure-sensitive adhesion properties can be obtained not only when the layer of pressure-sensitive adhesive is designed with corresponding viscoelasticity, but also when this applies in respect of the other layers of an adhesive tape, such as the carrier layer or a primer layer, for example.

Surprisingly and also unforeseeably for the skilled person, adhesive bonds produced using a polyurethane-based pressure-sensitive adhesive as described in at least one of the claims, more particularly in claim 1, and/or as described above in this specification prove to have excellent low-temperature impact strength in performance tests down to a temperature range of at least −30° C. to −40° C. Moreover, these adhesive bonds prove to be very vibration-resistant under load and over a relatively long time period. This was the case both when the PSA was used in its PSA function and when the PSA was used as a carrier layer or functional layer in an adhesive tape.

Surprisingly and also unforeseeably for the skilled person, even when there is branching present in the pressure-sensitively adhesive, hydroxyl-functionalized polyurethane prepolymer according to the invention, leading to the production of highly crosslinked polymer structures after reaction with the polyisocyanates of the invention, flowable components are produced at the same time, with particular advantage, to a degree which is sufficient for PSA applications. This is especially the case even when the reaction of the pressure-sensitively adhesive, hydroxyl-functionalized polyurethane prepolymer according to the invention with the polyisocyanates according to the invention takes place in an NCO/OH ratio of around 1.0. Higher NCO/OH ratios also lead to advantageous viscoelastic properties in relation to PSA applications. The NCO/OH ratio here means the ratio of the total number of isosycanate groups in the polyisocyanates to the total number of hydroxyl groups in the pressure-sensitively adhesive, hydroxyl-functionalized polyurethane prepolymer that are available for reaction with the isocyanate groups. In this specification, this NCO/OH ratio is also identified as “NCO/OH polyisocyanate:prepo”. This ratio is to be distinguished from the NCO/OH ratio of all of the NCO and OH groups that have entered up until that time in the course of the production of the pressure-sensitive adhesive of the invention, hence including the OH groups of the polyols which have entered into the preparation of the prepolymer. This latter NCO/OH ratio is identified in this specification as “NCO/OH total”.

The invention is to be described in more detail with reference to the following examples, without wishing thereby to restrict the invention.

The test methods below were used in order briefly to characterize the specimens produced in accordance with the invention:

### Dynamic Mechanical Analysis (DMA) for Determining the Storage Modulus G′ and the Loss Modulus G″

For characterizing the PSAs and also the pressure-sensitively adhesive, hydroxyl-functionalized polyurethane prepolymers, determinations of the storage modulus G′ and of the loss modulus G″ were made by means of Dynamic Mechanical Analysis (DMA).

The measurements were made using the shear stress-controlled rheometer DSR 200 N from Rheometric Scientific in an oscillation experiment with a sinusoidally oscillating shearing stress in a plate/plate arrangement. The storage modulus G′ and the loss modulus G″ were determined in a frequency sweep from 10⁻¹ to 10² rad/sec at a temperature of 25° C. G′ and G″ are defined as follows:

G′=τ/γ·cos(δ) (τ=shear stress, γ=deformation, δ=phase angle=phase shift between shear stress vector and deformation vector).
G″=τ/γ·sin(δ) (τ=shear stress, γ=deformation, δ=phase angle=phase shift between shear stress vector and deformation vector).

The definition of angular frequency is as follows: ω=2π·f (f=frequency). The unit is rad/sec.

The thickness of the samples measured was always between 0.9 and 1.1 mm (1±0.1 mm). The sample diameter was in each case 25 mm. Pre-tensioning took place with a load of 3N. For all of the measurements, the stress of the sample bodies was 2500 Pa.

### Dynamic Mechanical Analysis (DMA) for Determining the Complex Viscosity (η*)

For characterizing the pressure-sensitively adhesive, hydroxyl-functionalized polyurethane prepolymers, determinations of the complex viscosity were made by means of Dynamic Mechanical Analysis (DMA).

The measurements were made using the shear stress-controlled rheometer DSR 200 N from Rheometric Scientific in an oscillation experiment with a sinusoidally oscillating shearing stress in a plate/plate arrangement. The complex viscosity was determined in a temperature sweep from −50° C. to +250° C. with an oscillation frequency of 10 rad/s. The complex viscosity η* is defined as follows: η*=G*/ω

(G*=complex shear modulus, ω=angular frequency).

The further definitions are as follows: G*=\sqrt{(G′)²+(G″)²}

(G″=viscosity modulus (loss modulus), G′=elasticity modulus (storage modulus)).
G″=τ/γ·sin(δ) (τ=shear stress, γ=deformation, δ=phase angle=phase shift between shear stress vector and deformation vector).
G′=τ/γ·cos(δ) (τ=shear stress, γ=deformation, δ=phase angle=phase shift between shear stress vector and deformation vector).
ω=2π·f (f=frequency).

The thickness of the samples measured was always between 0.9 and 1.1 mm (1±0.1 mm). The sample diameter was in each case 25 mm. Pre-tensioning took place with a load of 3N. For all of the measurements, the stress of the sample bodies was 2500 Pa.

### Tack

The tack measurement (measurement of the surface adhesiveness) was carried out in accordance with the die measurement method based on ASTM D 2979-01 using the Texture Analyser TA 2 from SMS (Stable Micro Systems). According to this method, a cylindrical steel die is pressed with a defined pressing force and velocity onto the sample to be analysed, and after a defined time is withdrawn again at a defined velocity. The test result is the maximum force required for withdrawal, reported in the unit N.

The test parameters in detail were as follows:

Cylinder radius: 1 mm [symbol] cylinder area: 3.14 mm²
Pressing velocity: 0.1 mm/s
Pressing force: 5 N
Pressing time: 0.01 s
Withdrawal velocity: 0.6 mm/s

### Temperature: 23° C.+/−1° C.

Relative humidity: 50%+/−5%

### Bond Strength

The bond strength was determined in accordance with PSTC-101. According to this method, the adhesive strip for measurement was applied to various substrates (steel, ABS, PS, PC, PVC), pressed down twice with a 2 kg weight and then peeled off under defined conditions by means of a tensile testing machine. The peel angle was 90° or 180°, the peel speed 300 mm/min. The force required for peel removal is the bond strength, which is reported in the units N/cm. Some of the adhesive strips measured were backed for reinforcement with a 36 μm polyester film.

### Shear Test

The shear test was carried out in accordance with test specification PSTC-107. According to this method, the adhesive strip for measurement was applied to the substrate (steel), pressed on four times using a 2 kg weight, and then exposed to a constant shearing load. The holding time is ascertained, in minutes.

The bond area was in each case 13×20 mm². The shearing load on this bond area was 1 kg. Measurement was carried out at room temperature (23° C.) and at 70° C. Some of the adhesive strips measured were backed for reinforcement with a 36 μm polyester film.

### Thickness

The thickness measurements were carried out in accordance with test specification PSTC-33 using a thickness measurement device from Wolf-Messtechnik GmbH. The force with which the disc bore on the adhesive strip to be measured was 0.3 N or 4 N. The diameter of the disc was 10 mm.

The pressure-sensitively adhesive, hydroxyl-functionalized polyurethane prepolymers were manufactured in a customary heatable and evacuable mixing vessel with dissolver stirrer mechanism, from the company Molteni. During the mixing operation, which lasted about two hours in each case, the temperature of the mixture was adjusted to about 70° C. to 100° C. In those cases where no solvent was used, vacuum was applied in order to degass the components.

The reaction of the pressure-sensitively adhesive, hydroxyl-functionalized polyurethane prepolymers according to the invention with the polyisocyanates according to the invention took place, in those cases where the pressure-sensitively adhesive, hydroxyl-functionalized polyurethane prepolymer was used solventlessly, in a twin-screw extruder from the company Leistritz, Germany, ref. LSM 30/34. The assembly was heated electrically from the outside to about 70° C. to 90° C. and was air-cooled via a variety of fans, and was designed so as to ensure effective mixing of prepolymer and polyisocyanates with a short residence time in the extruder. For this purpose, the mixing screws of the twin-screw extruder were arranged such that conveying elements alternated with mixing elements. The respective polyisocyanates were added with suitable metering equipment, using metering assistants, into the unpressured conveying zones of the twin-screw extruder.

After the chemically reacting mixture, with a temperature of around 80° C., had emerged from the twin-screw extruder (exit: circular die 5 mm in diameter), its shaping to a film took place directly by means of a downstream two-roll applicator unit, between two incoming, double-sidedly siliconized, 50 μm polyester films. The feed rate was varied between 1 m/min and 20 m/min. After the film had cooled and therefore solidified, one of the incoming, double-sidedly siliconized polyester films was immediately removed again. This then gave a windable film (layer).

Some of the films (layers) wound onto siliconized polyester film were unwound again after a two-week storage period at room temperature, and laminated to the pressure-sensitive polyacrylate adhesive Durotac 280-1753 from the company National Starch, which was present in the form of an adhesive ready-coated out in a thickness of 50 μm onto siliconized polyester film. The lamination took place without further pretreatment. The experiments with the polyacrylate PSA served to test out use as a carrier layer or as a functional layer in an adhesive tape.

In some of the experiments, the pressure-sensitively adhesive, hydroxyl-functionalized polyurethane prepolymers according to the invention were dissolved in acetone before being used. The fraction of acetone was always 40% by weight. The reaction of the pressure-sensitively adhesive, hydroxyl-functionalized polyurethane prepolymers according to the invention with the polyisocyanates according to the invention then took place in a customary, heatable and evacuable mixing vessel with dissolver stirrer mechanism, from the company Molteni, at room temperature. The mixing time was 15 to 30 minutes. A chemically reacting mixture of this kind, comprising a pressure-sensitively adhesive, hydroxyl-functionalized polyurethane prepolymer with the polyisocyanates according to the invention, in acetone, was coatable for approximately 24 to 48 hours in general, with catalyst levels of between 0.05% and 0.2%, until gradual gelling occurred. Table 1 lists the base materials used for producing the polyurethane-based PSA, in each case with trade name and manufacturer. The stated raw materials are all freely available commercially.

TABLE 1
Base materials used to produce the chemically crosslinked polyurethane films

| | | | OH or NCO | |
|---|---|---|---|---|
| | | Number- | number | |
| | | average | (mmol OH/kg | |
| | | molar | or | |
| | | mass Mₙ | mmol | Manufacturer/ |
| Trade name | Chemical basis | (g/mol) | NCO/kg) | supplier |
| Voranol P 400 ® | Polypropylene glycol, diol | 400 | 4643 | Dow |
| Voranol 2000L ® | Polypropylene glycol, diol | 2000 | 989 | Dow |
| Voranol CP 6055 ® | Polypropylene glycol, triol | 6000 | 491 | Dow |
| MPDiol ® | 2-Methyl-1,3-propanediol | 90.12 | 22 193 | Lyondell |
| Vestanat IPDI ® | Isophorone diisocyanate | | 8998 | Degussa |
| | (IPDI) | | | |
| Desmodur W ® | Dicyclohexylmethane | | 7571 | Bayer |
| | diisocyanate | | | |
| Desmodur N 3400 ® | Mixture of aliphatic | | 5190 | Bayer |
| | polyisocyanates based on | | | |
| | hexamethylene | | | |
| | diisocyanate, | | | |
| | diisocyanate fraction: | | | |
| | 83% (amount-of- | | | |
| | substance fraction) | | | |
| Desmodur N 3300 ® | Mixture of aliphatic | | 5190 | Bayer |
| | polyisocyanates based on | | | |
| | hexamethylene | | | |
| | diisocyanate, having an | | | |
| | isocyanate functionality of | | | |
| | in each case three or | | | |
| | more than three | | | |
| Tinuvin 292 ® | Sterically hindered amine, | | | Ciba |
| | light stabilizer and ageing | | | |
| | inhibitor | | | |
| Tinuvin 400 ® | Triazine derivative, UV | | | Ciba |
| | protectant | | | |
| Coscat 83 ® | Bismuth trisneodecanoate | | | Caschem |
| | CAS No. 34364-26-6 | | | |
| Aerosil R 202 ® | Fumed silica, | | | Evonik |
| | hydrophobicized | | | |
| Expancel 092 DETX | Pre-expanded | | | Akzo Nobel |
| 100 d25 ® | microspheres, average | | | |
| | particle size 100 μm, | | | |
| | density: 25 kg/m³ | | | |

### EXAMPLES

### Example 1

The pressure-sensitively adhesive, hydroxyl-functionalized polyurethane prepolymer was prepared by homogeneously mixing and therefore chemically reacting the following starting materials in the proportions specified:

TABLE 2
Composition of the pressure-sensitively adhesive, hydroxyl-functionalized
polyurethane prepolymer, Example 1

| | | Amounts of | | Percentage |
|---|---|---|---|---|
| | | substance of | | ratio of the |
| | | OH or NCO groups | | number of |
| | | corresponding | | molecules |
| | Weight | to the respective | Percentage ratio | carrying OH |
| | fraction | weight fraction | of the number of | groups to one |
| | (% by | (mmol OH or | OH groups to | another |
| Starting material | weight) | mmol NCO) | one another | (idealized)* |
| Voranol P 400 ® | 17.32 | 80.4 | 41.0 | 42.3 |
| VoranolCP 6055 ® | 35.97 | 17.7 | 9.0 | 6.1 |
| MP Diol ® | 3.63 | 80.4 | 41.0 | 42.3 |
| Voranol 2000L ® | 17.86 | 17.7 | 9.0 | 9.3 |
| Tinuvin 400 ® | 0.63 | | | |
| Tinuvin 292 ® | 0.31 | | | |
| Coscat 83 ® | 0.21 | | | |
| Aerosil R202 ® | 2.10 | | | |
| Expancel 551 DE 80 | 1.89 | | | |
| d42 ® | | | | |
| Total | | 196.2 | 100.0 | 100.0 |
| Vestanat IPDI ® | 20.09 | 180.7 | | |
| Total | 100.0 | | | |

*calculated from the weight fractions and the OH numbers or NCO numbers of the starting materials, under the highly idealized assumption that the Voranol P400 and the Voranol 2000 L have a functionality of exactly 2, and the Voranol CP 6055 has a functionality of exactly 3.

To start with, all of the starting materials listed, apart from the MP Diol and the Vestanat IPDI, were mixed at a temperature of 70° C. and a pressure of 100 mbar for 1.5 hours. The MP Diol was then mixed in for 15 minutes, and subsequently the Vestanat IPDI, likewise over a time of 15 minutes. As a result of the heat of reaction produced, the mixture underwent heating to 100° C., and was then dispensed into storage containers.

The NCO/OH ratio of the prepolymer was 0.92. 100 g of the pressure-sensitively adhesive, hydroxyl-functionalized polyurethane prepolymer contained 15.5 mmol of OH groups. 9.0% of the hydroxyl groups introduced to form the pressure-sensitively adhesive, hydroxyl-functionalized polyurethane prepolymer originate from a polypropylene glycol having a functionality of more than two and a number-average molar mass of 6000 g/mol. Accordingly around 6.1% of the starting-material molecules carrying OH groups are trifunctional.

The resulting prepolymer was pressure-sensitively adhesive at room temperature.

The complex viscosity η* at room temperature (23° C.) was 16 000 Pas. The resulting prepolymer was meltable.

### Further Data:

G′ (at 10⁰ rad/sec and 23° C.): 0.02 MPa
G″ (at 10⁰ rad/sec and 23° C.): 0.04 MPa
G′ (at 10¹ rad/sec and 23° C.): 0.1 MPa
G″ (at 10¹ rad/sec and 23° C.): 0.2 MPa

### Tack: 6.5 N

For some of the experiments the prepolymer was dissolved in acetone.

The pressure-sensitively adhesive, hydroxyl-functionalized polyurethane prepolymer was reacted in each case with the following polyisocyanate mixtures, according to the invention, to give the PSA of the invention:

### Example 1a

TABLE 3
Composition of the polyisocyanate mixture, Example 1a

| | | Amount of | | |
|---|---|---|---|---|
| | | substance of NCO, | | |
| | | corresponding to | Amount of | Amount of |
| | | the respective | substance of | substance of |
| | Weight fraction | weight fraction | diisocyanate | triisocyanate* |
| Polyisocyanate | (% by weight) | (mmol NCO) | (mmol) | (mmol) |
| Desmodur N3400 | 89.4 | 464 | 177.5 | 36.4 |
| Desmodur N3300 | 10.6 | 55 | — | 18.3 |
| Total | 100.0 | 519 | 177.5 | 54.7 |

*idealized consideration: functionalities of more than three are not included in the calculations.

Triisocyanate fraction of the polyisocyanate mixture: 23.6% (amount-of-substance fraction)

### Example 1b

TABLE 4
Composition of the polyisocyanate mixture, Example 1b

| | | Amount of | | |
|---|---|---|---|---|
| | | substance of NCO, | | |
| | | corresponding to | Amount of | Amount of |
| | | the respective | substance of | substance of |
| | Weight fraction | weight fraction | diisocyanate | triisocyanate* |
| Polyisocyanate | (% by weight) | (mmol NCO) | (mmol) | (mmol) |
| Desmodur N3400 | 36.4 | 188.9 | 72.3 | 14.8 |
| Desmodur N3300 | 63.6 | 330.1 | — | 110.0 |
| Total | 100.0 | 519.0 | 72.3 | 124.8 |

*idealized consideration: functionalities of more than three are not included in the calculations.

Triisocyanate fraction of the polyisocyanate mixture: 63.3% (amount-of-substance fraction)

### Example 1c

TABLE 5
Composition of the polyisocyanate mixture, Example 1c

| | | Amount of | | |
|---|---|---|---|---|
| | | substance of NCO, | | |
| | | corresponding to | Amount of | Amount of |
| | | the respective | substance of | substance of |
| | Weight fraction | weight fraction | diisocyanate | triisocyanate* |
| Polyisocyanate | (% by weight) | (mmol NCO) | (mmol) | (mmol) |
| Desmodur W | 43.4 | 329 | 164.5 | — |
| Desmodur N3300 | 56.6 | 294 | — | 98 |
| Total | 100.0 | 623 | 164.5 | 98 |

*idealized consideration: functionalities of more than three are not included in the calculations.

Triisocyanate fraction of the polyisocyanate mixture: 37.3% (amount-of-substance fraction)

For preparing a PSA, the prepolymer in solution in acetone was mixed at room temperature with the polyisocycanate mixture (Examples 1a to 1c). The respective mixing ratios are listed in Table 6. The NCO/OH ratio of all the NCO and OH groups admitted up till then in the course of preparation (identified in the table and below by “NCO/OH total”) was in each case 1.05. A large part of the OH groups originally present had already been consumed for reaction to form the prepolymer. Based on the weight fractions listed in Table 2, there were still 15.5 mmol of OH available for reaction with the polyisocyanate. The ratio of the total number of isocyanate groups in the polyisocyanates to the total number of hydroxyl groups in the pressure-sensitively adhesive, hydroxyl-functionalized polyurethane prepolymer that were available for reaction with the isocyanate groups was always 1.6. This NCO/OH ratio is referred to in the table and below as “NCO/OH polyisocyanate:prepo”. The mixtures were coated onto a polyester film 25 μm thick. The solvent was evaporated off at 70° C. This gave a 50 μm layer on polyester film, which was characterized using the test methods described.

To produce a PSA intended for use as a carrier for an adhesive tape, the prepolymer was supplied continuously in each case to a twin-screw extruder preheated to 80° C. The polyisocyanate mixture (Examples 1a to 1c) was supplied continuously to the twin-screw extruder at the same time as the prepolymer and at the same location as the prepolymer. The polyisocyanate mixture metered in each case was one of the polyisocyanate mixtures from Examples 1a to 1c.

In each case, again, an NCO/OH total ratio of 1.05 was established.

The mixing ratios, again, can be taken from Table 6.

Conveying and mixing were carried out continuously. The time before exit of the extrudate from the extruder was in each case approximately two minutes.

The extrudate was in each case supplied directly to a two-roll applicator mechanisms, where it was coated between two incoming, double-sidedly siliconized polyester films and hence shaped to form a film. The thickness of the film was in each case 1.0 mm. In each case after cooling to room temperature, the film was wound up, after one of the two siliconized polyester films in each case had been removed. The wound film was stored at room temperature for two weeks in each case.

It was then partly unwound again, and in each case was laminated to the polyacrylate PSA Durotac 280-1753 from National Starch, present in the form of adhesive ready-coated onto siliconized polyester film in a thickness of 50 μm. Lamination took place in each case without pretreatment. Each of the experiments with the polyacrylate PSA served to trial the use of the PSA as a carrier layer or as a functional layer in an adhesive tape. This assembly was in each case characterized likewise by the test methods described. Moreover, the unwound part of the film in each case, as a single-layer adhesive tape 1 mm thick, was characterized with the test methods described. In this case, the PSA fulfilled the simultaneous, dual functions of carrier and PSA.

TABLE 6
Polyisocyanate mixture:prepolymer mixing ratios

| | Example | Example | Example |
|---|---|---|---|
| | 1a | 1b | 1c |
| Polyisocyanate mixture:prepolymer | 100:4.86 | 100:4.86 | 100:4.06 |
| mixing ratio | (parts by | (parts by | (parts by |
| | weight) | weight) | weight) |
| NCO/OH total | 1.05 | 1.05 | 1.05 |
| NCO/OH polyisocyanate:prepo | 1.6 | 1.6 | 1.6 |

Test results:

TABLE 7
Test results, Example 1a

| | Example 1a | | |
|---|---|---|---|
| | | Adhesive tape in three- | |
| | | layer construction: | |
| | | Durotac 280-1753/PU | |
| | PU PSA, thickness: | PSA (thickness: 1.0 mm)/ | PU PSA, single layer |
| | 50 μm on PET film | Durotac 280-1753 | thickness: 1.0 mm |
| G′ (at 10⁰ rad/sec and | | | 0.1 MPa |
| 23° C.) | | | |
| G″ (at 10⁰ rad/sec and | | | 0.03 MPa |
| 23° C.) | | | |
| G′ (at 10¹ rad/sec and | | | 0.18 MPa |
| 23° C.) | | | |
| G″ (at 10¹ rad/sec and | | | 0.09 MPa |
| 23° C.) | | | |
| Tack | | | 5.3N |
| Bond strength, steel, | 5.3 N/cm | 21.4 N/cm | 11.3 N/cm |
| 300 mm/min | (peel angle: 180°) | (backing reinforcement, | (backing reinforcement, |
| | | peel angle: 90°) | peel angle: 90°) |
| Bond strength, ABS, 300 mm/min | 4.8 N/cm | 20.2 N/cm | 10.4 N/cm |
| | (peel angle: 180°) | (Backing reinforcement, | (Backing reinforcement, |
| | | peel angle: 90°) | peel angle: 90°) |
| Bond strength, PS, 300 mm/min | 5.1 N/cm | 22.1 N/cm | 9.3 N/cm |
| | (peel angle: 180°) | (Backing reinforcement, | (Backing reinforcement, |
| | | peel angle: 90°) | peel angle: 90°) |
| Bond strength, PC, 300 mm/min | 5.7 N/cm | 19.0 N/cm | 10.8 N/cm |
| | (peel angle: 180°) | (Backing reinforcement, | (Backing reinforcement, |
| | | peel angle: 90°) | peel angle: 90°) |
| Bond strength, PVC, 300 mm/min | 4.3 N/cm | 21.9 N/cm | 11.0 N/cm |
| (N/cm) | (peel angle: 180°) | (Backing reinforcement, | (Backing reinforcement, |
| | | peel angle: 90°) | peel angle: 90°) |
| Holding time in the | >10 000 min | >10 000 min | >10 000 min |
| shear test at room | | (Backing reinforcement) | (Backing reinforcement) |
| temperature, 1 kg | | | |
| loading | | | |
| Holding time in the | >10 000 min | >10 000 min | >10 000 min |
| shear test at 70° C., 1 kg | | (Backing reinforcement) | (Backing reinforcement) |
| loading | | | |

For comparison, the bond strength of the PSA Durotac 280-1753, applied as a 50 μm layer to a 25 μm polyester film, was 5.9 N/cm.

All of the specimens showed equal properties in longitudinal and transverse directions.

The thickness of the specimens was consistent. For the specimens 1.0 mm thick, the standard deviation in the thickness was 0.03 mm.

Bonds with specimens of the three-layer construction Durotac 280-1753/PU PSA (thickness: 1.0 mm)/Durotac 280-1753, and in the single-layer construction, were subjected to performance tests.

In the temperature range from −30° C. to −40° C., they proved to have excellent low-temperature impact strength. Furthermore, these bonds proved to be highly vibration-resistant under load and over a relatively long time period.

TABLE 8
Test results, Example 1b

| | Example 1b | | |
|---|---|---|---|
| | | Adhesive tape in three- | |
| | | layer construction: | |
| | | Durotac 280-1753/PU | |
| | PU PSA, thickness: | PSA (thickness: 1.0 mm)/ | PU PSA, single layer |
| | 50 μm on PET film | Durotac 280-1753 | thickness: 1.0 mm |
| G′ (at 10⁰ rad/sec and | | | 0.2 MPa |
| 23° C.) | | | |
| G″ (at 10⁰ rad/sec and | | | 0.05 MPa |
| 23° C.) | | | |
| G′ (at 10¹ rad/sec and | | | 0.23 MPa |
| 23° C.) | | | |
| G″ (at 10¹ rad/sec and | | | 0.17 MPa |
| 23° C.) | | | |
| Tack | | | 4.1N |
| Bond strength, steel, | 4.1 N/cm | 17.8 N/cm | 9.3 N/cm |
| 300 mm/min | (peel angle: 180°) | (Backing reinforcement, | (Backing reinforcement, |
| | | peel angle: 90°) | peel angle: 90°) |
| Bond strength, ABS, 300 mm/min | 3.9 N/cm | 17.2 N/cm | 9.6 N/cm |
| | (peel angle: 180°) | (Backing reinforcement, | (Backing reinforcement, |
| | | peel angle: 90°) | peel angle: 90°) |
| Bond strength, PS, 300 mm/min | 4.8 N/cm | 16.1 N/cm | 9.2 N/cm |
| | (peel angle: 180°) | (Backing reinforcement, | (Backing reinforcement, |
| | | peel angle: 90°) | peel angle: 90°) |
| Bond strength, PC, 300 mm/min | 5.4 N/cm | 18.9 N/cm | 10.9 N/cm |
| | (peel angle: 180°) | (Backing reinforcement, | (Backing reinforcement, |
| | | peel angle: 90°) | peel angle: 90°) |
| Bond strength, PVC, 300 mm/min | 4.6 N/cm | 16.2 N/cm | 9.0 N/cm |
| (N/cm) | (peel angle: 180°) | (Backing reinforcement, | (Backing reinforcement, |
| | | peel angle: 90°) | peel angle: 90°) |
| Holding time in the | >10 000 min | >10 000 min | >10 000 min |
| shear test at room | | (Backing reinforcement) | (Backing reinforcement) |
| temperature, 1 kg | | | |
| loading | | | |
| Holding time in the | >10 000 min | >10 000 min | >10 000 min |
| shear test at 70° C., 1 kg | | (Backing reinforcement) | (Backing reinforcement) |
| loading | | | |

For comparison, the bond strength of the PSA Durotac 280-1753, applied as a 50 μm layer to a 25 μm polyester film, was 5.9 N/cm.

All of the specimens showed equal properties in longitudinal and transverse directions.

The thickness of the specimens was consistent. For the specimens 1.0 mm thick, the standard deviation in the thickness was 0.03 mm.

Bonds with specimens of the three-layer construction Durotac 280-1753/PU PSA (thickness: 1.0 mm)/Durotac 280-1753, and in the single-layer construction, were subjected to performance tests.

In the temperature range from −30° C. to −40° C., they proved to have excellent low-temperature impact strength. Furthermore, these bonds proved to be highly vibration-resistant under load and over a relatively long time period.

TABLE 9
Test results, Example 1c

| | Example 1c | | |
|---|---|---|---|
| | | Adhesive tape in three- | |
| | | layer construction: | |
| | | Durotac 280-1753/PU | |
| | PU PSA, Thickness: | PSA (thickness: 1.0 mm)/ | PU PSA single layer |
| | 50 μm on PET film | Durotac 280-1753 | thickness: 1.0 mm |
| G′ (at 10⁰ rad/sec and | | | 0.12 MPa |
| 23° C.) | | | |
| G″ (at 10⁰ rad/sec and | | | 0.04 MPa |
| 23° C.) | | | |
| G′ (at 10¹ rad/sec and | | | 0.20 MPa |
| 23° C.) | | | |
| G″ (at 10¹ rad/sec and | | | 0.14 MPa |
| 23° C.) | | | |
| Tack | | | 6.7N |
| Bond strength, steel, | 5.7 N/cm | 24.1 N/cm | 1753 N/cm |
| 300 mm/min | (peel angle: 180°) | (Backing reinforcement, | (Backing reinforcement, |
| | | peel angle: 90°) | peel angle: 90°) |
| Bond strength, ABS, 300 mm/min | 5.1 N/cm | 25.2 N/cm | 14.8 N/cm |
| | (peel angle: 180°) | (Backing reinforcement, | (Backing reinforcement, |
| | | peel angle: 90°) | peel angle: 90°) |
| Bond strength, PS, 300 mm/min | 4.1 N/cm | 24.7 N/cm | 15.3 N/cm |
| | (peel angle: 180°) | (Backing reinforcement, | (Backing reinforcement, |
| | | peel angle: 90°) | peel angle: 90°) |
| Bond strength, PC, 300 mm/min | 4.8 N/cm | 23.9 N/cm | 15.0 N/cm |
| | (peel angle: 180°) | (Backing reinforcement, | (Backing reinforcement, |
| | | peel angle: 90°) | peel angle: 90°) |
| Bond strength, PVC, 300 mm/min | 3.3 N/cm | 24.0 N/cm | 12.1 N/cm |
| (N/cm) | (peel angle: 180°) | (Backing reinforcement, | (Backing reinforcement, |
| | | peel angle: 90°) | peel angle: 90°) |
| Holding time in the | >10 000 min | >10 000 min | >10 000 min |
| shear test at room | | (Backing reinforcement) | (Backing reinforcement) |
| temperature, 1 kg | | | |
| loading | | | |
| Holding time in the | >10 000 min | >10 000 min | >10 000 min |
| shear test at 70° C., 1 kg | | (Backing reinforcement) | (Backing reinforcement) |
| loading | | | |

For comparison, the bond strength of the PSA Durotac 280-1753, applied as a 50 μm layer to a 25 μm polyester film, was 5.9 N/cm.

All of the specimens showed equal properties in longitudinal and transverse directions.

The thickness of the specimens was consistent. For the specimens 1.0 mm thick, the standard deviation in the thickness was 0.03 mm.

The thickness in the case of the 1.0 mm specimens was always 1.0+/−0.05 mm.

Bonds with specimens of the three-layer construction Durotac 280-1753/PU PSA (thickness: 1.0 mm)/Durotac 280-1753, and in the single-layer construction, were subjected to performance tests.

In the temperature range from −30° C. to −40° C., they proved to have excellent low-temperature impact strength. Furthermore, these bonds proved to be highly vibration-resistant under load and over a relatively long time period.

### Example 2

The pressure-sensitively adhesive, hydroxyl-functionalized polyurethane prepolymer was prepared by homogeneously mixing and therefore chemically reacting the following starting materials in the proportions specified:

TABLE 10
Composition of the pressure-sensitively adhesive, hydroxyl-functionalized
polyurethane prepolymer, Example 2

| | | Amounts of | | |
|---|---|---|---|---|
| | | substance of | | |
| | | OH or NCO | | Percentage ratio |
| | | groups | | of the number of |
| | | corresponding | | molecules |
| | Weight | to the respective | Percentage ratio | carrying OH |
| | fraction | weight fraction | of the number of | groups to one |
| | (% by | (mmol OH or | OH groups to one | another |
| Starting material | weight) | mmol NCO) | another | (idealized)* |
| Voranol P 400 ® | 38.92 | 180.7 | 65.5 | 67.6 |
| VoranolCP 6055 ® | 27.68 | 13.6 | 5.0 | 3.4 |
| MP Diol ® | 3.49 | 77.4 | 28.5 | 29.0 |
| Tinuvin 400 ® | 0.63 | | | |
| Tinuvin 292 ® | 0.32 | | | |
| Coscat 83 ® | 0.21 | | | |
| Total | | 271.7 | 100 | 100 |
| Vestanat IPDI ® | 28.75 | 258.7 | | |
| Total | 100.0 | | | |

*calculated from the weight fractions and the OH numbers or NCO numbers of the starting materials, under the highly idealized assumption that the Voranol P400 has a functionality of exactly 2, and the Voranol CP 6055 has a functionality of exactly 3.

To start with, all of the starting materials listed, apart from the MP Diol and the Vestanat IPDI, were mixed at a temperature of 70° C. and a pressure of 100 mbar for 1.5 hours. The MP Diol was then mixed in for 15 minutes, and subsequently the Vestanat IPDI, likewise over a time of 15 minutes. As a result of the heat of reaction produced, the mixture underwent heating to 100° C., and was then dispensed into storage containers.

The NCO/OH ratio of the prepolymer was 0.95. 100 g of the pressure-sensitively adhesive, hydroxyl-functionalized polyurethane prepolymer contained 13.0 mmol of OH groups. 5.0% of the hydroxyl groups introduced to form the pressure-sensitively adhesive, hydroxyl-functionalized polyurethane prepolymer originate from a polypropylene glycol having a functionality of more than two and a number-average molar mass of 6000 g/mol. Accordingly around 3.4% of the starting-material molecules carrying OH groups are trifunctional.

The resulting prepolymer was pressure-sensitively adhesive at room temperature.

The complex viscosity η* at room temperature (23° C.) was 35 000 Pas. The resulting prepolymer was meltable.

### Further Data:

G′ (at 10⁰ rad/sec and 23° C.): 0.02 MPa
G″ (at 10⁰ rad/sec and 23° C.): 0.04 MPa
G′ (at 10¹ rad/sec and 23° C.): 0.10 MPa
G″ (at 10¹ rad/sec and 23° C.): 0.13 Mpa

### Tack: 6.8 N

For some of the experiments the prepolymer was dissolved in acetone.

The pressure-sensitively adhesive, hydroxyl-functionalized polyurethane prepolymer was reacted in each case with the following polyisocyanate mixtures, according to the invention, to give the PSA of the invention:

### Example 2a

TABLE 11
Composition of the polyisocyanate mixture, Example 2a

| | | Amount of | | |
|---|---|---|---|---|
| | | substance of NCO, | | |
| | | corresponding to | Amount of | Amount of |
| | | the respective | substance of | substance of |
| | Weight fraction | weight fraction | diisocyanate | triisocyanate* |
| Polyisocyanate | (% by weight) | (mmol NCO) | (mmol) | (mmol) |
| Desmodur N3400 | 66.7 | 346 | 132.3 | 27.1 |
| Desmodur N3300 | 33.3 | 173 | — | 57.7 |
| Total | 100.0 | 519 | 132.3 | 84.8 |

*idealized consideration: functionalities of more than three are not included in the calculations.

Triisocyanate fraction of the polyisocyanate mixture: 39.1% (amount-of-substance fraction)

### Example 2b

TABLE 12
Composition of the polyisocyanate mixture, Example 2b

| | | Amount of | | |
|---|---|---|---|---|
| | | substance of NCO, | | |
| | | corresponding to | Amount of | Amount of |
| | | the respective | substance of | substance of |
| | Weight fraction | weight fraction | diisocyanate | triisocyanate* |
| Polyisocyanate | (% by weight) | (mmol NCO) | (mmol) | (mmol) |
| Desmodur W | 18.5 | 140.1 | 70.1 | — |
| Desmodur N3300 | 81.5 | 423.0 | — | 141.0 |
| Total | 100.0 | 563.1 | 70.1 | 141.0 |

*idealized consideration: functionalities of more than three are not included in the calculations.

Triisocyanate fraction of the polyisocyanate mixture: 66.8% (amount-of-substance fraction)

For preparing a PSA, the prepolymer in solution in acetone was mixed at room temperature with the polyisocycanate mixture (Examples 2a and 2b). The respective mixing ratios are listed in Table 13. The NCO/OH ratio of all the NCO and OH groups admitted up till then in the course of preparation (identified in the table and below by “NCO/OH total”) was in each case 1.05. A large part of the OH groups originally present had already been consumed for reaction to form the prepolymer. Based on the weight fractions listed in Table 10, there were still 13.0 mmol of OH available for reaction with the polyisocyanate. The ratio of the total number of isocyanate groups in the polyisocyanates to the total number of hydroxyl groups in the pressure-sensitively adhesive, hydroxyl-functionalized polyurethane prepolymer that were available for reaction with the isocyanate groups was always 2.0. This NCO/OH ratio is referred to in Table 13 and below as “NCO/OH polyisocyanate:prepo”. The mixtures were coated onto a polyester film 25 μm thick. The solvent was evaporated off at 70° C. This gave a 50 μm layer on polyester film, which was characterized using the test methods described.

To produce a PSA intended for use as a carrier for an adhesive tape, the prepolymer was supplied continuously in each case to a twin-screw extruder preheated to 80° C. The polyisocyanate mixture (Examples 2a and 2b) was supplied continuously to the twin-screw extruder at the same time as the prepolymer and at the same location as the prepolymer. The polyisocyanate mixture metered in each case was one of the polyisocyanate mixtures from Examples 2a and 2b.

In each case, again, an NCO/OH total ratio of 1.05 was established.

The mixing ratios, again, can be taken from Table 13.

Conveying and mixing were carried out continuously. The time before exit of the extrudate from the extruder was in each case approximately two minutes.

The extrudate was in each case supplied directly to a two-roll applicator mechanism, where it was coated between two incoming, double-sidedly siliconized polyester films and hence shaped to form a film. The thickness of the film was in each case 1.0 mm. In each case after cooling to room temperature, the film was wound up, after one of the two siliconized polyester films in each case had been removed. The wound film was stored at room temperature for two weeks in each case.

It was then partly unwound again, and in each case was laminated to the polyacrylate PSA Durotac 280-1753 from National Starch, present in the form of adhesive ready-coated onto siliconized polyester film in a thickness of 50 μm. Lamination took place in each case without pretreatment. Each of the experiments with the polyacrylate PSA served to trial the use of the PSA as a carrier layer or as a functional layer in an adhesive tape. This assembly was in each case characterized likewise by the test methods described. Moreover, the unwound part of the film in each case, as a single-layer adhesive tape 1 mm thick, was characterized with the test methods described. In this case, the PSA fulfilled the simultaneous, dual functions of carrier and PSA.

TABLE 13
Polyisocyanate mixture:prepolymer mixing ratios

| | Example 2a | Example 2b |
|---|---|---|
| Polyisocyanate mixture:prepolymer | 100:5.11 | 100:4.72 |
| mixing ratio | (parts by | (parts by |
| | weight) | weight) |
| NCO/OH total | 1.05 | 1.05 |
| NCO/OH polyisocyanate:prepo | 2.0 | 2.0 |

### Test Results:

TABLE 14
Test results, Example 2a

| | Example 2a | | |
|---|---|---|---|
| | | Adhesive tape in three- | |
| | | layer construction: | |
| | | Durotac 280-1753/PU | |
| | PU PSA, thickness: | PSA (thickness: 1.0 mm)/ | PU PSA single layer |
| | 50 μm on PET film | Durotac 280-1753 | thickness: 1.0 mm |
| G′ (at 10⁰ rad/sec and | | | 0.21 MPa |
| 23° C.) | | | |
| G″ (at 10⁰ rad/sec and | | | 0.12 MPa |
| 23° C.) | | | |
| G′ (at 10¹ rad/sec and | | | 0.40 MPa |
| 23° C.) | | | |
| G″ (at 10¹ rad/sec and | | | 0.21 MPa |
| 23° C.) | | | |
| Tack | | | 6.0N |
| Bond strength, steel, | 6.9 N/cm | 22.3 N/cm | 16.0 N/cm |
| 300 mm/min | (peel angle: 180°) | (Backing reinforcement, | (Backing reinforcement, |
| | | peel angle: 90°) | peel angle: 90°) |
| Bond strength, ABS, 300 mm/min | 6.6 N/cm | 23.9 N/cm | 15.7 N/cm |
| | (peel angle: 180°) | (Backing reinforcement, | (Backing reinforcement, |
| | | peel angle: 90°) | peel angle: 90°) |
| Bond strength, PS, 300 mm/min | 6.3 N/cm | 19.1 N/cm | 15.3 N/cm |
| | (peel angle: 180°) | (Backing reinforcement, | (Backing reinforcement, |
| | | peel angle: 90°) | peel angle: 90°) |
| Bond strength, PC, 300 mm/min | 6.9 N/cm | 18.0 N/cm | 16.1 N/cm |
| | (peel angle: 180°) | (Backing reinforcement, | (Backing reinforcement, |
| | | peel angle: 90°) | peel angle: 90°) |
| Bond strength, PVC, 300 mm/min | 6.2 N/cm | 23.1 N/cm | 17.3 N/cm |
| (N/cm) | (peel angle: 180°) | (Backing reinforcement, | (Backing reinforcement, |
| | | peel angle: 90°) | peel angle: 90°) |
| Holding time in the | >10 000 min | >10 000 min | >10 000 min |
| shear test at room | | (Backing reinforcement) | (Backing reinforcement) |
| temperature, 1 kg | | | |
| loading | | | |
| Holding time in the | >10 000 min | >10 000 min | >10 000 min |
| shear test at 70° C., 1 kg | | (Backing reinforcement) | (Backing reinforcement) |
| loading | | | |

For comparison, the bond strength of the PSA Durotac 280-1753, applied as a 50 μm layer to a 25 μm polyester film, was 5.9 N/cm.

All of the specimens showed equal properties in longitudinal and transverse directions.

The thickness of the specimens was consistent. For the specimens 1.0 mm thick, the standard deviation in the thickness was 0.03 mm.

Bonds with specimens of the three-layer construction Durotac 280-1753/PU PSA (thickness: 1.0 mm)/Durotac 280-1753, and in the single-layer construction, were subjected to performance tests.

In the temperature range from −30° C. to −40° C., they proved to have excellent low-temperature impact strength. Furthermore, these bonds proved to be highly vibration-resistant under load and over a relatively long time period.

TABLE 14
Test results, Example 2b

| | Example 2b | | |
|---|---|---|---|
| | | Adhesive tape in three- | |
| | | layer construction: | |
| | | Durotac 280-1753/PU | |
| | PU PSA, thickness: | PSA (thickness: 1.0 mm)/ | PU PSA single layer |
| | 50 μm on PET film | Durotac 280-1753 | thickness: 1.0 mm |
| G′ (at 10⁰ rad/sec and | | | 0.26 MPa |
| 23° C.) | | | |
| G″ (at 10⁰ rad/sec and | | | 0.16 MPa |
| 23° C.) | | | |
| G′ (at 10¹ rad/sec and | | | 0.5 MPa |
| 23° C.) | | | |
| G″ (at 10¹ rad/sec and | | | 0.29 MPa |
| 23° C.) | | | |
| Tack | | | 6.2N |
| Bond strength, steel, | 7.1 N/cm | 20.7 N/cm | 17.5 N/cm |
| 300 mm/min | (peel angle: 180°) | (Backing reinforcement, | (Backing reinforcement, |
| | | peel angle: 90°) | peel angle: 90°) |
| Bond strength, ABS, 300 mm/min | 6.9 N/cm | 21.2 N/cm | 15.3 N/cm |
| | (peel angle: 180°) | (Backing reinforcement, | (Backing reinforcement, |
| | | peel angle: 90°) | peel angle: 90°) |
| Bond strength, PS, 300 mm/min | 6.5 N/cm | 22.0 N/cm | 15.8 N/cm |
| | (peel angle: 180°) | (Backing reinforcement, | (Backing reinforcement, |
| | | peel angle: 90°) | peel angle: 90°) |
| Bond strength, PC, 300 mm/min | 6.1 N/cm | 19.5 N/cm | 17.2 N/cm |
| | (peel angle: 180°) | (Backing reinforcement, | (Backing reinforcement, |
| | | peel angle: 90°) | peel angle: 90°) |
| Bond strength, PVC, 300 mm/min | 6.6 N/cm | 21.1 N/cm | 16.8 N/cm |
| (N/cm) | (peel angle: 180°) | (Backing reinforcement, | (Backing reinforcement, |
| | | peel angle: 90°) | peel angle: 90°) |
| Holding time in the | >10 000 min | >10 000 min | >10 000 min |
| shear test at room | | (Backing reinforcement) | (Backing reinforcement) |
| temperature, 1 kg | | | |
| loading | | | |
| Holding time in the | >10 000 min | >10 000 min | >10 000 min |
| shear test at 70° C., 1 kg | | (Backing reinforcement) | (Backing reinforcement) |
| loading | | | |

For comparison, the bond strength of the PSA Durotac 280-1753, applied as a 50 μm layer to a 25 μm polyester film, was 5.9 N/cm.

All of the specimens showed equal properties in longitudinal and transverse directions.

The thickness of the specimens was consistent. For the specimens 1.0 mm thick, the standard deviation in the thickness was 0.03 mm.

Bonds with specimens of the three-layer construction Durotac 280-1753/PU PSA (thickness: 1.0 mm)/Durotac 280-1753, and in the single-layer construction, were subjected to performance tests.

In the temperature range from −30° C. to −40° C., they proved to have excellent low-temperature impact strength. Furthermore, these bonds proved to be highly vibration-resistant under load and over a relatively long time period.

### Example 3

The pressure-sensitively adhesive, hydroxyl-functionalized polyurethane prepolymer was prepared by homogeneously mixing and therefore chemically reacting the following starting materials in the proportions specified:

TABLE 15
Composition of the pressure-sensitively adhesive, hydroxyl-functionalized
polyurethane prepolymer, Example 3

| | | Amounts of | | Percentage |
|---|---|---|---|---|
| | | substance of | | ratio of the |
| | | OH or NCO groups | | number of |
| | | corresponding | | molecules |
| | | to the respective | Percentage ratio | carrying OH |
| | Weight | weight fraction | of the number of | groups to one |
| | fraction | (mmol OH or | OH groups to one | another |
| Starting material | (% by weight) | mmol NCO) | another | (idealized)* |
| Voranol P 400 ® | 48.34 | 224.4 | 75.0 | 75.0 |
| MP Diol ® | 2.70 | 59.9 | 20.0 | 20.0 |
| Voranol 2000L ® | 15.13 | 15.0 | 5.0 | 5.0 |
| Tinuvin 400 ® | 0.64 | | | |
| Tinuvin 292 ® | 0.32 | | | |
| Coscat 83 ® | 0.20 | | | |
| Total | | 299.3 | 100.0 | 100.0 |
| Vestanat IPDI ® | 32.67 | 293.9 | | |
| Total | 100.0 | | | |

*calculated from the weight fractions and the OH numbers or NCO numbers of the starting materials, under the highly idealized assumption that the Voranol P400 and the Voranol 2000 L have a functionality of exactly 2.

To start with, all of the starting materials listed, apart from the MP Diol and the Vestanat IPDI, were mixed at a temperature of 70° C. and a pressure of 100 mbar for 1.5 hours. The MP Diol was then mixed in for 15 minutes, and subsequently the Vestanat IPDI, likewise over a time of 15 minutes. As a result of the heat of reaction produced, the mixture underwent heating to 100° C., and was then dispensed into storage containers.

The NCO/OH ratio of the prepolymer was 0.98. 100 g of the pressure-sensitively adhesive, hydroxyl-functionalized polyurethane prepolymer contained 5.4 mmol of OH groups. 0.0% of the hydroxyl groups introduced to form the pressure-sensitively adhesive, hydroxyl-functionalized polyurethane prepolymer originate from a polypropylene glycol having a functionality of more than two. Accordingly none of the starting-material molecules carrying OH groups is trifunctional.

The resulting prepolymer was pressure-sensitively adhesive at room temperature.

The complex viscosity η* at room temperature (23° C.) was 22 000 Pas. The resulting prepolymer was meltable.

### Further Data:

G′ (at 10⁰ rad/sec and 23° C.): 0.007 MPa
G″ (at 10⁰ rad/sec and 23° C.): 0.02 MPa
G′ (at 10¹ rad/sec and 23° C.): 0.09 MPa
G″ (at 10¹ rad/sec and 23° C.): 0.17 Mpa

### Tack: 1.9 N

For some of the experiments the prepolymer was dissolved in acetone.

The pressure-sensitively adhesive, hydroxyl-functionalized polyurethane prepolymer was reacted in each case with the following polyisocyanate mixture, according to the invention, to give the PSA of the invention:

### Example 3a

TABLE 16
Composition of the polyisocyanate mixture, Example 3a

| | | Amount of | | |
|---|---|---|---|---|
| | | substance of NCO, | | |
| | | corresponding to | Amount of | Amount of |
| | | the respective | substance of | substance of |
| | Weight fraction | weight fraction | diisocyanate | triisocyanate* |
| Polyisocyanate | (% by weight) | (mmol NCO) | (mmol) | (mmol) |
| Desmodur W | 18.6 | 140.8 | 70.4 | — |
| Desmodur N3300 | 81.4 | 422.5 | — | 140.8 |
| Total | 100.0 | 563.3 | 70.4 | 140.8 |

*idealized consideration: functionalities of more than three are not included in the calculations.

Triisocyanate fraction of the polyisocyanate mixture: 66.7% (amount-of-substance fraction)

For preparing a PSA, the prepolymer in solution in acetone was mixed at room temperature with the polyisocycanate mixture (Example 3a). The respective mixing ratios are listed in Table 17. The NCO/OH ratio of all the NCO and OH groups admitted up till then in the course of preparation (identified in the table and below by “NCO/OH total”) was in each case 1.1. A large part of the OH groups originally present had already been consumed for reaction to form the prepolymer. Based on the weight fractions listed in Table 15, there were still 5.4 mmol of OH available for reaction with the polyisocyanate. The ratio of the total number of isocyanate groups in the polyisocyanates to the total number of hydroxyl groups in the pressure-sensitively adhesive, hydroxyl-functionalized polyurethane prepolymer that were available for reaction with the isocyanate groups was 6.5. This NCO/OH ratio is referred to in the table and below as “NCO/OH polyisocyanate:prepo”. The mixtures were coated onto a polyester film 25 μm thick. The solvent was evaporated off at 70° C. This gave a 50 μm layer on polyester film, which was characterized using the test methods described.

To produce a PSA intended for use as a carrier for an adhesive tape, the prepolymer was supplied continuously to a twin-screw extruder preheated to 80° C. The polyisocyanate mixture (Example 3a) was supplied continuously to the twin-screw extruder at the same time as the prepolymer and at the same location as the prepolymer. The polyisocyanate mixture metered in was the polyisocyanate mixture from Example 3a.

In each case, again, an NCO/OH total ratio of 1.1 was established.

The mixing ratio, again, can be taken from Table 17.

Conveying and mixing were carried out continuously. The time before exit of the extrudate from the extruder was approximately two minutes.

The extrudate was supplied directly to a two-roll applicator mechanism, where it was coated between two incoming, double-sidedly siliconized polyester films and hence shaped to form a film. The thickness of the film was 1.0 mm. After cooling to room temperature, the film was wound up, after one of the two siliconized polyester films had been removed. The wound film was stored at room temperature for two weeks.

It was then partly unwound again, and was laminated to the polyacrylate PSA Durotac 280-1753 from National Starch, present in the form of adhesive ready-coated onto siliconized polyester film in a thickness of 50 μm. Lamination took place without pretreatment. The experiments with the polyacrylate PSA served to trial the use of the PSA as a carrier layer or as a functional layer in an adhesive tape. This assembly was likewise characterized likewise by the test methods described. Moreover, the unwound part of the film, as a single-layer adhesive tape 1 mm thick, was characterized with the test methods described. In this case, the PSA fulfilled the simultaneous, dual functions of carrier and PSA.

TABLE 17
Polyisocyanate mixture:prepolymer mixing ratio

| | Example 3a |
|---|---|
| Polyisocyanate mixture:prepolymer | 100:6.27 (parts |
| mixing ratio | by weight) |
| NCO/OH total | 1.1 |
| NCO/OH polyisocyanate:prepo | 6.5 |

### Test Results:

TABLE 18
Test results, Example 3a

| | Example 3a | | |
|---|---|---|---|
| | | Adhesive tape in three- | |
| | | layer construction: | |
| | | Durotac 280-1753/PU | |
| | PU PSA, thickness: | PSA (thickness: 1.0 mm)/ | PU PSA single layer |
| | 50 μm on PET film | Durotac 280-1753 | thickness: 1.0 mm |
| G′ (at 10⁰ rad/sec and | | | 0.07 MPa |
| 23° C.) | | | |
| G″ (at 10⁰ rad/sec and | | | 0.14 MPa |
| 23° C.) | | | |
| G′ (at 10¹ rad/sec and | | | 0.21 MPa |
| 23° C.) | | | |
| G″ (at 10¹ rad/sec and | | | 0.28 MPa |
| 23° C.) | | | |
| Tack | | | 1.3N |
| Bond strength, steel, | 3.8 N/cm | 12.4 N/cm | 9.3 N/cm |
| 300 mm/min | (peel angle: 180°) | (Backing reinforcement, | (Backing reinforcement, |
| | | peel angle: 90°) | peel angle: 90°) |
| Bond strength, ABS, 300 mm/min | 2.7 N/cm | 14.2 N/cm | 9.7 N/cm |
| | (peel angle: 180°) | (Backing reinforcement, | (Backing reinforcement, |
| | | peel angle: 90°) | peel angle: 90°) |
| Bond strength, PS, 300 mm/min | 3.5 N/cm | 14.1 N/cm | 10.3 N/cm |
| | (peel angle: 180°) | (Backing reinforcement, | (Backing reinforcement, |
| | | peel angle: 90°) | peel angle: 90°) |
| Bond strength, PC, 300 mm/min | 3.7 N/cm | 15.0 N/cm | 10.8 N/cm |
| | (peel angle: 180°) | (Backing reinforcement, | (Backing reinforcement, |
| | | peel angle: 90°) | peel angle: 90°) |
| Bond strength, PVC, 300 mm/min | 3.2 N/cm | 11.9 N/cm | 10.8 N/cm |
| (N/cm) | (peel angle: 180°) | (Backing reinforcement, | (Backing reinforcement, |
| | | peel angle: 90°) | peel angle: 90°) |
| Holding time in the | >10 000 min | >10 000 min | >10 000 min |
| shear test at room | | (Backing reinforcement) | (Backing reinforcement) |
| temperature, 1 kg | | | |
| loading | | | |
| Holding time in the | >10 000 min | >10 000 min | >10 000 min |
| shear test at 70° C., 1 kg | | (Backing reinforcement) | (Backing reinforcement) |
| loading | | | |

For comparison, the bond strength of the PSA Durotac 280-1753, applied as a 50 μm layer to a 25 μm polyester film, was 5.9 N/cm.

All of the specimens showed equal properties in longitudinal and transverse directions.

The thickness of the specimens was consistent. For the specimens 1.0 mm thick, the standard deviation in the thickness was 0.03 mm.

Bonds with specimens of the three-layer construction Durotac 280-1753/PU PSA (thickness: 1.0 mm)/Durotac 280-1753, and in the single-layer construction, were subjected to performance tests.

In the temperature range from −30° C. to −40° C., they proved to have excellent low-temperature impact strength. Furthermore, these bonds proved to be highly vibration-resistant under load and over a relatively long time period.

1. Polyurethane-based pressure-sensitive adhesive wherein the polyurethane comprises the chemical reaction product of at least the following starting materials:
a) polyisocyanates comprising at least one aliphatic or alicyclic diisocyanate and at least one aliphatic or alicyclic polyisocyanate having an isocyanate functionality of three or more than three, the amount-of-substance fraction of the aliphatic or alicyclic polyisocyanates having an isocyanate functionality of three or more than three as a proportion of the polyisocyanates being at least 18 per cent, and
b) at least one pressure-sensitively adhesive, hydroxyl-functionalized polyurethane prepolymer.

2. Pressure-sensitive adhesive according to claim 1, wherein the amount-of-substance fraction of the aliphatic or alicyclic polyisocyanates having an isocyanate functionality of three or more than three as a proportion of the polyisocyanates is in the range from at least 20 per cent to at most 90 per cent.

3. Pressure-sensitive adhesive according to claim 1, wherein the complex viscosity η* of the pressure-sensitively adhesive, hydroxyl-functionalized polyurethane prepolymer, measured by means of Dynamic Mechanical Analysis in a plate/plate arrangement at room temperature with an oscillation frequency of 10 rad/s, is greater than or equal to 8000 Pas.

4. Pressure-sensitive adhesive according to wherein the pressure-sensitively adhesive, hydroxyl-functionalized polyurethane prepolymer has a hydroxyl functionality of greater than 2.

5. Pressure-sensitive adhesive according to claim 1, wherein the ratio of the total number of isocyanate groups in the polyisocyanates to the total number of hydroxyl groups in the pressure-sensitively adhesive, hydroxyl-functionalized polyurethane prepolymer that are available for reaction of the isocyanate groups is in the range from 0.9 to 5.0.

6. Pressure-sensitive adhesive according to claim 1, wherein the adhesive comprises further additives selected from the group consisting of microbeads, fillers, rheological additives, resins, plasticizers, light stabilizers, UV protectants, and ageing inhibitors.

7. Pressure-sensitive adhesive according to claim 1, wherein said starting materials include at least one catalyst for the reaction.

8. Pressure-sensitive adhesive according to claim 1, wherein the adhesive is foamed.

9. Pressure-sensitively adhesive, shaped structure, comprising at least one pressure-sensitive adhesive according to claim 1.

10. Adhesive tape comprising at least one pressure-sensitively adhesive layer, which layer comprises at least one pressure-sensitive adhesive according to claim 1.

11. Process for preparing the pressure-sensitive adhesive of claim 1, wherein at least the following starting materials are reacted:
a) polyisocyanates comprising at least one aliphatic or alicyclic diisocyanate and at least one aliphatic or alicyclic polyisocyanate having an isocyanate functionality of three or more than three, the amount-of-substance fraction of the aliphatic or alicyclic polyisocyanates having an isocyanate functionality of three or more than three as a proportion of the polyisocyanates being at least 18 per cent, and
b) at least one pressure-sensitively adhesive, hydroxyl-functionalized polyurethane prepolymer.

12. Process according to claim 11, wherein the reaction of the polyisocyanates with the pressure-sensitively adhesive, hydroxyl-functionalized polyurethane prepolymer takes place continuously.

13. Process according to claim 11, wherein the reaction of the polyisocyanates with the pressure-sensitively adhesive, hydroxyl-functionalized polyurethane prepolymer is started solventlessly, in the melt.

14. Process according to claim 11, wherein the reaction of the polyisocyanates with the pressure-sensitively adhesive, hydroxyl-functionalized polyurethane prepolymer is started in an extrusion operation or coextrusion operation.

15. A pressure-sensitive adhesive layer and/or carrier layer and/or functional layer on an adhesive tape, comprising the pressure-sensitive adhesive of claim 1.
